(19) United States
(12) Patent Application Publication
(10) Pub. No.: US 2009/0226679 A1
(43) Pub. Date: Sep. 10, 2009

(54) INK SET, METHOD FOR PRODUCING INK JET RECORDED MATTER ON FABRIC AND INK JET RECORDED MATTER ON FABRIC

(75) Inventors: Masahiro YATAKE, Shiojiri-Shi (JP); Yoshimasa TAMURA, Shiojiri-Shi (JP)

Correspondence Address: LADAS & PARRY LLP, 26 WEST 61ST STREET, NEW YORK, NY, 10023, US

(73) Assignee: SEIKO EPSON CORPORATION.

(21) Appl. No.: 12/398,881

(22) Filed: Mar. 5, 2009

(30) Foreign Application Priority Data
Mar. 10, 2008 (JP) 2008-059097
Mar. 10, 2008 (JP) 2008-059099
Dec. 5, 2008 (JP) 2008-310595
Feb. 12, 2009 (JP) 2009-030340

(51) Int. Cl. B32B 3/10; C08L 33/10; C08K 3/04; B05D 5/00

(52) U.S. Cl. 428/195.1; 524/553; 524/560; 524/496; 427/288

(57) ABSTRACT

There are provided an ink set including an ink composition having excellent color developability, ejection stability, and fixity and a pigment fixer having excellent abrasion resistance and dry-cleaning resistance; a method for producing an ink jet recorded matter with the ink set, the ink jet recorded matter having excellent color developability, ejection stability, abrasion resistance, and dry-cleaning resistance; and an ink jet recorded matter obtained by the method.

An ink set includes an ink composition containing a water-dispersible pigment dispersoid and polymeric microparticles having a glass transition temperature of −10° C. or lower, an acid value of 100 mg KOH/g or less, and prepared using at least alkyl (meth)acrylate and/or cyclic alkyl (meth)acrylate, and a pigment fixer containing a reaction agent.

### CROSS-REFERENCES TO RELATED APPLICATIONS

The entire disclosure of Japanese Patent Application No. 2008-59097, filed on Mar. 10, 2008, No. 2008-59099, filed on Mar. 10, 2008, No. 2008-310595, filed on Dec. 5, 2008, No. 2009-030340, filed on Feb. 12, 2009, are expressly incorporated by reference herein.

### FIELD OF THE INVENTION

The present invention relates to an ink set including an ink composition having excellent color developability, ejection stability, and fixity and a pigment fixer having excellent abrasion resistance and dry-cleaning resistance; a method for producing an ink jet recorded matter with the ink set, the ink jet recorded matter having excellent color developability, ejection stability, abrasion resistance, and dry-cleaning resistance; and an ink jet recorded matter obtained by the method.

### BACKGROUND OF THE INVENTION

Inks used for ink jet recording are required to have the following characteristics: the inks do not spread and have good drying properties in printing on recording media, such as paper and fabrics; the inks can be uniformly printed on surfaces of various recording media; and adjacent colors are not mixed multicolor printing such as color printing.

In such inks, in particular, many of inks including pigments serving as colorants have been studied to reduce the wettability of the inks to surfaces of recording media by mainly reducing the permeability of the inks to the recording media and to ensure good print quality by arranging ink drops near surfaces of recording media and have been used practically. In inks having reduced wettability for recording media, however, the difference in the degree of spreading among recording media composed of different raw materials is large. In particular, in recycled paper containing various components of paper, there is a problem of the occurrence of spreading due to the difference in wettability of ink for the components. Furthermore, such inks requires prolonged periods of time to dry printed matter and thus have the problem of mixing of adjacent colors (the occurrence of color bleeding) in multicolor printing such as color printing. In addition, printed matter printed with pigment ink disadvantageously has reduced abrasion resistance due to the fact that the pigment is left on a surface of the recording media.

To overcome the foregoing problems, attempts have been made to improve the permeability of ink to recording media. For example, the addition of diethylene glycol monobutyl ether to ink (see Patent Document 1), the addition of Surfynol 465 (manufactured by Nissin Chemical Industry Co., Ltd.), which is an acetylenic glycol-based surfactant, to ink (see Patent Document 2), and the addition of both of these materials to ink (see Patent Document 3) have been examined.

It is generally difficult for inks containing pigments to improve the permeability of inks while the dispersion stability of pigments is ensured. Thus, the range of choice for penetrants is narrow. Hitherto, with respect to combinations of glycol ethers and pigments, for example, a combination of a pigment and triethylene glycol monomethyl ether (see Patent Document 4) and a combination of a pigment and an ether, e.g., ethylene glycol, diethylene glycol, or triethylene glycol, (see Patent Document 5) have been investigated.

Furthermore, an ink containing a dye (see Patent Document 6) and an ink relating to a binder (see Patent Document 7) are known as inks used for textile.

In addition, with respect to a technique for subjecting printed matter including an image and the like to pigment fixing treatment, a pigment fixer containing a predetermined compound and a method for fixing a pigment are known (see Patent Documents 8 and 9).

### RELATED ART

[Patent Document 1] U.S. Pat. No. 5,156,675

[Patent Document 2] U.S. Pat. No. 5,183,502

[Patent Document 3] U.S. Pat. No. 5,196,056

[Patent Document 4] JP-A-56-147861

[Patent Document 5] JP-A-9-111165

[Patent Document 6] JP-A-2007-515561

[Patent Document 7] JP-A-2007-126635

[Patent Document 8] JP-A-2005-281952

[Patent Document 9] JP-A-2004-149934

### SUMMARY OF THE INVENTION

### Problems to be Solved by the Invention

However, known pigment fixers have insufficient abrasion resistance and dry-cleaning resistance. An ink composition which is used for ink jet recording, which has excellent color developability, ejection stability, and fixity, and which is suitable for the production of printed matter having excellent abrasion resistance and dry-cleaning resistance has not been studied. Furthermore, the most suitable pigment fixer for such a specific ink composition has not been studied. Moreover, a method for producing a printed matter having excellent abrasion resistance and dry-cleaning resistance using the ink composition for use in jet recording and the pigment fixer has not been studied.

With respect to ink compositions for use in ink jet recording, known aqueous pigment inks have insufficient fixity, color density, and color developability for textile. Furthermore, known pigment dispersoids have disadvantages that the presence of materials, such as surfactants and glycol ethers, each having a hydrophilic portion and a hydrophobic portion in ink, is liable to cause adsorption and desorption of dispersed polymers from pigments, leading to unstable dispersibility, poor storage stability, and poor ejection stability. To reduce spreading of aqueous inks on recording media, aqueous inks generally need to contain materials, such as surfactants and glycol ethers, each having a hydrophilic portion and a hydrophobic portion. Inks that do not contain such materials disadvantageously have insufficient permeability to recording media and are thus liable to cause a reduction in the quality of printed images. In addition, for the purpose of performing uniform printing, the types and ranges of recording media are disadvantageously restricted.

Moreover, the use of a known pigment dispersoid and an additive (an acetylenic glycol- or acetylenic alcohol-based surfactant, di(tri)ethylene glycol monobutyl ether, (di)propylene glycol monobutyl ether, 1,2-alkylene glycol, or a mixture thereof), which may be contained in ink of the invention, disadvantageously results in poor long-term storage stability and poor redissolution properties of ink, so that the ink is dried to readily cause clogging of, for example, the tip of a nozzle of an ink jet head.

To overcome the foregoing problems, it is an object of the invention to provide an ink set including an ink composition having excellent color developability, ejection stability, and fixity and a pigment fixer having excellent abrasion resistance and dry-cleaning resistance; a method for producing an ink jet recorded matter with the ink set, the ink jet recorded matter having excellent color developability, ejection stability, abrasion resistance, and dry-cleaning resistance; and an ink jet recorded matter obtained by the method.

### Means for Solving the Problems

### APPLICATION EXAMPLE 1

An ink set of the present invention includes

an ink composition containing a water-dispersible pigment dispersoid and polymeric microparticles having a glass transition temperature of −10° C. or lower, an acid value of 100 mg KOH/g or less, and prepared using at least alkyl (meth)acrylate and/or cyclic alkyl (meth)acrylate, and

a pigment fixer containing a reaction agent.

### APPLICATION EXAMPLE 2

In the ink set according to Application Example 1 of the present invention, the ink composition further contains a reaction agent.

### APPLICATION EXAMPLE 3

In the ink set according to Application Example 1 or 2 of the present invention, the pigment fixer further contains polymeric microparticles having a glass transition temperature of −10° C. or lower, an acid value of 100 mg KOH/g or less, and prepared using at least alkyl (meth)acrylate and/or cyclic alkyl (meth)acrylate.

### APPLICATION EXAMPLE 4

In the ink set according to any one of Application Examples 1 to 3 of the present invention, the reaction agent is at least one selected from the group consisting of block isocyanates, oxazoline-containing polymers, and polycarbodiimides.

### APPLICATION EXAMPLE 5

In the ink set according to any one of Application Examples 1 to 4 of the present invention, the alkyl (meth)acrylate and/or cyclic alkyl (meth)acrylate is contained in an amount of 70% by mass or more with respect to the total amount of the polymeric microparticles.

### APPLICATION EXAMPLE 6

In the ink set according to any one of Application Examples 1 to 5 of the present invention, the alkyl (meth)acrylate and/or cyclic alkyl (meth)acrylate is alkyl (meth)acrylate having 1 to 24 carbon atoms and/or cyclic alkyl (meth)acrylate having 3 to 24 carbon atoms.

### APPLICATION EXAMPLE 7

In the ink set according to any one of Application Examples 1 to 6 of the present invention, the dispersoid has an average particle size of 50 nm to 300 nm.

### APPLICATION EXAMPLE 8

In the ink set according to Application Example 7 of the present invention, the dispersoid is self-dispersible carbon black capable of dispersing in water without a dispersant and having an average particle size of 50 nm to 300 nm.

### APPLICATION EXAMPLE 9

In the ink set according to Application Example 7 of the present invention, the dispersoid is a polymer-modified water-dispersible organic pigment having an average particle size of 50 nm to 300 nm, the polymer having a weight-average molecular weight of 10,000 to 200,000 in terms of styrene in gel permeation chromatography (GPC).

### APPLICATION EXAMPLE 10

In the ink set according to any one of Application Examples 1 to 9 of the present invention, the ink composition contains 1,2-alkylene glycol.

### APPLICATION EXAMPLE 11

In the ink set according to any one of Application Examples 1 to 10 of the present invention, the ink composition contains an acetylenic glycol-based surfactant and/or acetylenic alcohol-based surfactant.

### APPLICATION EXAMPLE 12

In the ink set according to any one of Application Examples 1 to 11 of the present invention, the polymeric microparticle content (percent by mass) is larger than the pigment content (percent by mass).

### APPLICATION EXAMPLE 13

A method for producing a printed fabric according to the present invention includes the steps of

ink-jet printing an ink composition on fabric, the ink composition containing a water-dispersible pigment dispersoid and polymeric microparticles having a glass transition temperature of −10° C. or lower, an acid value of 100 mg KOH/g or less, and prepared using at least alkyl (meth)acrylate and/or cyclic alkyl (meth)acrylate,

immersing the resulting printed matter in a pigment fixer containing a reaction agent, and

heat-treating the immersed printed matter at a temperature of 110° C. to 200° C. for 1 minute or more.

### APPLICATION EXAMPLE 14

A method for producing a printed fabric according to the present invention includes the steps of

ink-jet printing an ink composition on fabric, the ink composition containing a water-dispersible pigment dispersoid and polymeric microparticles having a glass transition temperature of −10° C. or lower, an acid value of 100 mg KOH/g or less, and prepared using at least alkyl (meth)acrylate and/or cyclic alkyl (meth)acrylate,

applying a pigment fixer containing a reaction agent to the resulting printed matter by an ink jet process, and

heat-treating the printed matter that has been subjected to the application at a temperature of 110° C. to 200° C. for 1 minute or more.

### APPLICATION EXAMPLE 15

In the method for producing a printed fabric according to Application Example 13 or 14 of the present invention, the ink composition further contains a reaction agent.

### APPLICATION EXAMPLE 16

In the method for producing a printed fabric according to any one of Application Examples 13 to 15 of the present invention, the pigment fixer further contains polymeric microparticles having a glass transition temperature of −10° C. or lower, an acid value of 100 mg KOH/g or less, and prepared using at least alkyl (meth)acrylate and/or cyclic alkyl (meth)acrylate.

### APPLICATION EXAMPLE 17

In the method for producing a printed fabric according to any one of Application Examples 13 to 16 of the present invention, the reaction agent is at least one selected from the group consisting of block isocyanates, oxazoline-containing polymers, and polycarbodiimides.

### APPLICATION EXAMPLE 18

In the method for producing a printed fabric according to any one of Application Examples 13 to 17 of the present invention, the alkyl (meth)acrylate and/or cyclic alkyl (meth)acrylate is contained in an amount of 70% by mass or more with respect to the total amount of the polymeric microparticles.

### APPLICATION EXAMPLE 19

In the method for producing a printed fabric according to any one of Application Examples 13 to 18 of the present invention, the alkyl (meth)acrylate and/or cyclic alkyl (meth)acrylate is alkyl (meth)acrylate having 1 to 24 carbon atoms and/or cyclic alkyl (meth)acrylate having 3 to 24 carbon atoms.

### APPLICATION EXAMPLE 20

In the method for producing a printed fabric according to any one of Application Examples 13 to 19 of the present invention, the dispersoid has an average particle size of 50 nm to 300 nm.

### APPLICATION EXAMPLE 21

In the method for producing a printed fabric according to Application Example 20 of the present invention, the dispersoid is self-dispersible carbon black capable of dispersing in water without a dispersant and having an average particle size of 50 nm to 300 nm.

### APPLICATION EXAMPLE 22

In the method for producing a printed fabric according to Application Example 20 of the present invention, the dispersoid is a polymer-modified water-dispersible organic pigment having an average particle size of 50 nm to 300 nm, the polymer having a weight-average molecular weight of 10,000 to 200,000 in terms of styrene in gel permeation chromatography (GPC).

### APPLICATION EXAMPLE 23

In the method for producing a printed fabric according to any one of Application Examples 13 to 22 of the present invention, the ink composition contains 1,2-alkylene glycol.

### APPLICATION EXAMPLE 24

In the method for producing a printed fabric according to any one of Application Examples 13 to 23 of the present invention, the ink composition contains an acetylenic glycol-based surfactant and/or acetylenic alcohol-based surfactant.

### APPLICATION EXAMPLE 25

In the method for producing a printed fabric according to any one of Application Examples 13 to 24 of the present invention, the polymeric microparticle content (percent by mass) is larger than the pigment content (percent by mass).

### APPLICATION EXAMPLE 26

A printed fabric of the present invention is produced by the method for producing a printed fabric according to any one of Application Examples 13 to 25.

### DETAILED DESCRIPTION OF THE PRESENT INVENTION

### Ink Set

An ink set includes

an ink composition containing a water-dispersible pigment dispersoid and polymeric microparticles having a glass transition temperature of −10° C. or lower, an acid value of 100 mg KOH/g or less, and prepared using at least alkyl (meth)acrylate and/or cyclic alkyl (meth)acrylate, and

a pigment fixer containing a reaction agent.

The configuration of the ink set will be described below.

### (Ink Composition)

### Pigment Dispersoid

The average particle size of a pigment dispersoid is measured by a light-scattering method. An average particle size of less than 50 nm results in a reduction in the color developability of printed matter or printed fabric. An average particle size exceeding 300 nm results in a reduction in fixity. Preferably, the average particle size is in the range of 70 nm to 230 nm and more preferably 80 nm to 130 nm.

As the pigment dispersoid, self-dispersible carbon black capable of dispersing in water without a dispersant and having an average particle size of 50 nm to 300 nm is preferably contained. The use of the self-dispersible carbon black improves the color developability of printed fabric. An example of a method for making self-dispersible carbon black capable of dispersing in water without a dispersant is a method for oxidizing surfaces of carbon black particles with ozone or sodium hypochlorite. The self-dispersible carbon black preferably has an average particle size of 50 nm to 150 nm. At an average particle size of less than 50 nm, it is difficult to provide color developability. An average particle size exceeding 150 nm results in a reduction in fixity. More preferably, the particle size is in the range of 70 nm to 130 nm and still more preferably 80 nm to 120 nm.

Furthermore, as the pigment dispersoid, a polymer-modified water-dispersible organic pigment having an average particle size of 50 nm to 300 nm, the polymer having a weight-average molecular weight of 10,000 to 200,000 in terms of styrene in gel permeation chromatography (GPC), is preferably contained, thereby improving the fixity of the pigment on printed fabric and the storage stability of a pigment ink itself. That is, the polymer is detached because of characteristics of a vehicle used in forming an ink composition and thus tends to have adverse effects. Specifically, the detached polymer and an acetylenic glycol-, acetylenic alcohol-, or silicon-based surfactant, di(tri)ethylene glycol monobutyl ether, dipropylene glycol monobutyl ether, 1,2-alkylene glycol, or a mixture thereof, which is an additive to improve print quality, are liable to attack an adhesive and the like constituting a head. A weight-average molecular weight exceeding 200,000 is liable to cause an increase in ink viscosity and results in difficulty in providing a stable dispersoid.

As the foregoing polymer, a polymer formed from a monomer or an oligomer containing an acryloyl group, a methacryloyl group, a vinyl group, or an allyl group having a double bond may be used.

The foregoing polymer preferably contains a carboxy group to impart hydrophilicity. With respect to a carboxy group, acrylic acid, methacrylic acid, crotonic acid, propylacrylic acid, isopropylacrylic acid, itaconic acid, and fumaric acid can be used. These may be used alone or in combination of two or more. Acrylic acid and/or methacrylic acid is preferred.

The foregoing polymer is preferably a copolymer mainly composed of a carboxy group-containing monomer and acrylate and/or methacrylate. The proportion of acrylic acid, methacrylic acid, acrylate, and methacrylate with respect to the total mass of all monomers is preferably 80% or more.

The foregoing polymer preferably contains benzyl acrylate and/or benzyl methacrylate in an amount of 40% by mass to 80% by mass (hereinafter, also expressed simply as “%”) with respect to the total mass of all monomers. The reason for this is as follows: A total mass of a benzyl group-containing acrylic monomer and a benzyl group-containing methacrylic monomer of less than 40% results in a reduction in color developability on plain paper such as PPC paper. At a total mass exceeding 80%, it is difficult to obtain dispersion stability. In the benzyl group-containing water-dispersible polymer, monomers other than benzyl acrylate and benzyl methacrylate are preferably acrylic acid and/or methacrylic acid and another acrylate and/or methacrylate. The benzyl group-containing water-dispersible polymer is preferably formed by copolymerization of only these monomers. As (meth)acrylate, butyl (meth)acrylate is preferably contained.

The foregoing polymer is preferably a copolymer from a monomer composition in which the proportion of acrylate and acrylic acid is 80% or more with respect to the total mass of all monomers. A proportion of less than 80% results in a reduction in fixity and glossiness on specialized paper. Examples of acrylate that can be used include commercially available acrylates, such as methyl acrylate, ethyl acrylate, propyl acrylate, butyl acrylate, hexyl acrylate, cyclohexyl acrylate, octyl acrylate, lauryl acrylate, 2-ethylhexyl acrylate, 2-ethylhexylcarbitol acrylate, phenol EO-modified acrylate, N-vinylpyrrolidone, isobornyl acrylate, benzyl acrylate, para-cumyl phenol EO-modified acrylate, and 2-hydroxyethyl-3-phenoxypropyl acrylate. Preferably, benzyl acrylate and/or butyl acrylate is used. More preferably, the polymer is a copolymer from a monomer containing benzyl acrylate in an amount of 40% to 80% with respect to the total mass of all monomers.

The foregoing polymer can be prepared by a known process, such as solution polymerization or emulsion polymerization. To stably disperse the pigment dispersoid in ink, a water-dispersible or water-soluble polymer or surfactant may be added as a dispersion stabilizer in addition to the foregoing polymer. At least 70% of the foregoing polymer is preferably constituted by a polymer prepared by copolymerization of (meth)acrylate and (meth)acrylic acid because of satisfactory dispersion stability.

Particularly preferred examples of the pigment for black ink include carbon black (C.I. Pigment Black 7) such as furnace black, lamp black, acetylene black, and channel black. Copper oxide, iron oxide (C.I. Pigment Black 11), metals such as titanium oxide, and organic pigments such as aniline black (C.I. Pigment Black 1) can also be used.

Examples of the pigment for color ink include C.I. Pigment Yellows 1 (Fast Yellow G), 3, 12 (Disazo Yellow AAA), 13, 14, 17, 24, 34, 35, 37, 42 (yellow iron oxide), 53, 55, 74, 81, 83 (Disazo Yellow HR), 93, 94, 95, 97, 98, 100, 101, 104, 108, 109, 110, 117, 120, 128, 138, 153, 155, 180, and 185; C.I. Pigment Reds 1, 2, 3, 5, 17, 22 (brilliant first scarlet), 23, 31, 38, 48:2 (permanent red 2B (Ba)), 48:2 (permanent red 2B (Ca)), 48:3 (permanent red 2B (Sr)), 48:4 (permanent red 2B (Mn)), 49:1, 52:2, 53:1, 57:1 (brilliant carmine 6B), 60:1, 63:1, 63:2, 64:1, 81 (rhodamine 6G lake), 83, 88, 101 (iron red), 104, 105, 106, 108 (cadmium red), 112, 114, 122 (quinacridone magenta), 123, 146, 149, 166, 168, 170, 172, 177, 178, 179, 185, 190, 193, 202, 206, 209, and 219; C.I. Pigment Violets 19 and 23; C.I. Pigment Orange 36; C.I. Pigment Blues 1, 2, 15 (phthalocyanine blue R), 15:1, 15:2, 15:3 (phthalocyanine blue G), 15:4, 15:6 (phthalocyanine blue E), 16, 17:1, 56, 60, and 63; and C.I. Pigment Greens 1, 4, 7, 8, 10, 17, 18, and 36. Various pigments can be used as colorants.

The foregoing pigment is dispersed with a disperser. Various commercially available dispersers can be used as the disperser. From the viewpoint of achieving low contamination levels, a media-less disperser is preferred. Specific examples thereof include a wet jet mill (Genus Co., Ltd.), Nanomizer (Nanomizer Inc.), a homogenizer (Gaulin), Ultimizer (Sugino Machine Limited), and Microfluidizer (Microfluidics).

The amount of the pigment added is preferably in the range of 0.5% to 30% and more preferably 1.0% to 15%. At an added amount of 0.5% or less, the print density cannot be ensured. An added amount of 30% or more increases ink viscosity and results in structural viscosity in viscosity characteristics, thereby being liable to cause a deterioration in the stability of the ejection of ink from an ink jet head.

### Polymeric Microparticles

The glass transition temperature of polymeric microparticles is −10° C. or lower, thereby improving the fixity of the pigment on printed fabric. A glass transition temperature exceeding −10° C. results in a gradual reduction in the fixity of the pigment. The glass transition temperature is preferably −15° C. or lower and more preferably −20° C. or lower.

The acid value of the polymeric microparticles is 100 mg KOH/g or less. An acid value exceeding 100 mg KOH/g results in a reduction in the cleaning resistance of printed fabric. The acid value is preferably 50 mg KOH/g or less and more preferably 30 mg KOH/g or less.

The polymeric microparticles preferably have a molecular weight of 100,000 or more and more preferably 200,000 or more. A molecular weight of less than 100,000 results in a reduction in the cleaning resistance of printed fabric.

As the alkyl (meth)acrylate and/or cyclic alkyl (meth)acrylate contained in the polymeric microparticles, alkyl (meth)acrylate having 1 to 24 carbon atoms and/or cyclic alkyl (meth)acrylate having 3 to 24 carbon atoms are preferred. Examples thereof include methyl (meth)acrylate, ethyl (meth)acrylate, propyl (meth)acrylate, n-butyl (meth)acrylate, isobutyl (meth)acrylate, pentyl (meth)acrylate, hexyl (meth)acrylate, 2-ethylhexyl (meth)acrylate, octyl (meth)acrylate, nonyl (meth)acrylate, decyl (meth)acrylate, t-butylcyclohexyl (meth)acrylate, lauryl (meth)acrylate, isobornyl (meth)acrylate, cetyl (meth)acrylate, stearyl (meth)acrylate, isostearyl (meth)acrylate, tetramethylpiperidyl (meth)acrylate, dicyclopentanyl (meth)acrylate, dicyclopentenyl (meth)acrylate, dicyclopentenyloxy (meth)acrylate, and behenyl (meth)acrylate.

Furthermore, the alkyl (meth)acrylate and/or cyclic alkyl (meth)acrylate is preferably contained in an amount of 70% by mass or more with respect to the total amount of the polymeric microparticles because color fastness to rubbing (dry and wet) and dry-cleaning resistance of printed fabric are further improved.

The polymeric microparticles preferably have a weight-average molecular weight of 100,000 to 1,000,000 in terms of styrene in gel permeation chromatography (GPC). A weight-average molecular weight within this range results in improvement in the fixity of the pigment on printed fabric.

The average particle size of the polymeric microparticles is measured by a light-scattering method. The average particle size of the polymeric microparticles measured by the light-scattering method is preferably in the range of 50 nm to 500 nm and more preferably 60 nm to 300 nm. An average particle size of less than 50 nm results in a reduction in the fixity of printed fabric. An average particle size exceeding 500 nm results in a reduction in dispersion stability. Furthermore, in the case where a pigment fixer is applied by ink jet printing, the ejection from an ink jet head tends to be unstable.

### 1,2-Alkylene Glycol

The ink preferably contains 1,2-alkylene glycol. The use of 1,2-alkylene glycol reduces the spreading of the ink on printed matter and printed fabric to improve print quality. Preferred examples of 1,2-alkylene glycol include 1,2-alkylene glycol having 5 or 6 carbon atoms, e.g., 1,2-hexanediol, 1,2-pentanediol, and 4-methyl-1,2-pentanediol. Among these, 1,2-hexanediol and 4-methyl-1,2-pentanediol having 6 carbon atoms are preferred. The amount of 1,2-alkylene glycol added is preferably in the range of 0.3% to 30% and more preferably 0.5% to 10%.

### Glycol Ether

The ink preferably contains glycol ether because glycol ether reduces the spreading of the ink on printed matter and printed fabric. As the glycol ether, one or two or more of glycol ethers selected from diethylene glycol monobutyl ether, triethylene glycol monobutyl ether, propylene glycol monobutyl ether, and dipropylene glycol monobutyl ether are preferably used. The amount of glycol ether added is preferably in the range of 0.1% to 20% and more preferably 0.5% to 10%.

Acetylenic Glycol-Based Surfactant and/or Acetylenic Alcohol-Based Surfactant Ink preferably contains an acetylenic glycol-based surfactant and/or acetylenic alcohol-based surfactant. The use of the acetylenic glycol-based surfactant and/or acetylenic alcohol-based surfactant further reduces the spreading of the ink to improve print quality. The addition thereof improves drying properties of print and enables high-speed printing.

One or more selected from 2,4,7,9-tetramethyl-5-decyne-4,7-diol, alkylene oxide adducts of 2,4,7,9-tetramethyl-5-decyne-4,7-diol, 2,4-dimethyl-5-decyn-4-ol, and alkylene oxide adducts of 2,4-dimethyl-5-decyn-4-ol is preferable as the acetylenic glycol-based surfactant and/or acetylenic alcohol-based surfactant. These can be commercially available as, for example, Olfine 104 series and E series such as Olfine E1010 manufactured by Air Products (UK) and Surfynol 465 and Surfynol 61 manufactured by Nissin Chemical Industry Co., Ltd.

In the present invention, the use of one or two or more selected from 1,2-alkylene glycol, the acetylenic glycol-based surfactant and/or acetylenic alcohol-based surfactant, and glycol ether further reduces spreading of ink.

### Additional Component

The foregoing ink may further contain a reaction agent because color fastness to rubbing (dry and wet) and dry-cleaning resistance of printed fabric are further improved. The reaction agent will be described below as a component constituting a pigment fixer.

In the ink set, it is preferred that the (total) amount (percent by mass) of the polymeric microparticles and/or the reaction agent contained in the ink and/or the pigment fixer be larger than the pigment content of the ink. In particular, it is more preferred that the (total) amount (percent by mass) of the polymeric microparticles in the ink and/or the pigment fixer be larger than the pigment content of the ink. Thereby, the fixity of the pigment on printed fabric is improved.

For example, in order to ensure the storage stability of the ink and the stable ejection of the ink from an ink jet head, improve clogging, and prevent deterioration of the ink, the ink may appropriately contain various additives, such as a humectant, a solubilizing aid, a permeation controlling agent, a viscosity adjusting agent, a pH adjuster, a solubilizing aid, an antioxidant, a preservative, a fungicide, a corrosion inhibitor, and a chelate configured to capture metal ions that affect the dispersion.

The foregoing ink is preferably an ink for use in an ink jet recording method.

### (Pigment Fixer)

The pigment fixer of the invention includes a reaction agent.

### Reaction Agent

A known compound can be used as the reaction agent. Any compound can be used as long as a functional group in the reaction agent can be subjected to appropriate treatment such as heat treatment to react with a pigment dispersant (e.g., a resin) or the foregoing polymeric microparticles in the ink or a material (e.g., cellulose) constituting, for example, fabric which is a target receiving the ink and the pigment fixer ejected. Alternatively, a crosslinkable compound that can react with the pigment dispersant, the polymeric microparticles, or the material constituting, for example, fabric can be used in the presence of an appropriate initiating reagent. The reaction agent may be a monofunctional compound or a polyfunctional compound.

In the ink set of the invention, at least one selected from block isocyanates, oxazoline-containing polymers, and polycarbodiimides is preferably used as the reaction agent in order that the ink set can be used for ink jet recording.

### Block Isocyanate

Block isocyanates are inactive compounds at room temperature and prepared by reacting free isocyanate groups of isocyanate group-terminated precursors with active hydrogen-containing compounds (blocking agents). Heating block isocyanates results in the dissociation of block agents, thereby regenerating isocyanate groups.

The block isocyanate is preferably a polyisocyanate provided in the form of an aqueous emulsion. Commercially available examples thereof include NK Linker BX manufactured by Shin-Nakamura Chemical Co., Ltd. and Fixer FX conc manufactured by Matsui Shikiso Chemical Co., Ltd. The block isocyanate can also be prepared by a method described in JP-A-2007-45867.

### Oxazoline-Containing Polymer

The oxazoline-containing polymer is preferably in the form of an aqueous emulsion or a water-soluble polymer. Commercially available examples thereof include NK Linker FX manufactured by Shin-Nakamura Chemical Co., Ltd. and Epocros K-2010, Epocros K-2020, Epocros K-2030, Epocros WS-500, and Epocros WS-700 manufactured by Nippon Shokubai Co., Ltd.

### Polycarbodiimide

The polycarbodiimide is preferably in the form of an aqueous emulsion or a water-soluble polymer. Commercially available examples thereof include Carbodilite SV-02, V-02, V-02-L2, V-04, E-01, and E-02 manufactured by Nisshinbo Industries, Inc. The reaction of a carbodiimide group of the polycarbodiimide with a carboxyl group occurs readily in acidic conditions or at a high temperature. In view of storage stability, the ink or pigment fixer needs to be alkaline. A volatile alkaline compound such as ammonia is preferable as an alkaline compound added to the ink or pigment fixer. An organic amine, e.g., triethanolamine or triisopropanolamine, may be used. The pH is preferably in the range of 8 to 11 and more preferably 8.5 to 10. The polycarbodiimide preferably has a molecular weight of 3,000 to 100,000. A molecular weight of less than 3,000 results in a reduction in the storage stability of the ink or pigment fixer. At a molecular weight exceeding 100,000, the reaction of a carbodiimide group with a carboxyl group does not readily proceed. More preferably, the molecular weight is in the range of 5,000 to 30,000.

### Additional Components

In addition to the reaction agent, the pigment fixer may further contain polymeric microparticles having a glass transition temperature of −10° C. or lower, an acid value of 100 mg KOH/g or less, and prepared using at least alkyl (meth)acrylate and/or cyclic alkyl (meth)acrylate because color fastness to rubbing (dry and wet) and dry-cleaning resistance of printed fabric are further improved.

In addition to the component imparting the fixity of the pigment to printed fabric, the pigment fixer may suitably contain, for example, 1,2-alkylene glycol, glycol ether, and the acetylenic glycol-based surfactant and/or acetylenic alcohol-based surfactant contained in the ink.

### {Method for Producing Printed Fabric}

A method for producing a printed fabric according to the present invention includes the steps of ink-jet printing an ink composition on fabric, the ink composition containing a water-dispersible pigment dispersoid and polymeric microparticles having a glass transition temperature of −10° C. or lower, an acid value of 100 mg KOH/g or less, and prepared using at least alkyl (meth)acrylate and/or cyclic alkyl (meth)acrylate, immersing the resulting printed matter in a pigment fixer containing a reaction agent that reacts with the polymeric microparticles, and heat-treating the immersed printed matter at a temperature of 110° C. to 200° C. for 1 minute or more.

Furthermore, a method for producing a printed fabric according to the present invention includes ink-jet printing an ink composition on fabric, the ink composition containing a water-dispersible pigment dispersoid and polymeric microparticles having a glass transition temperature of −10° C. or lower, an acid value of 100 mg KOH/g or less, and prepared using at least alkyl (meth)acrylate and/or cyclic alkyl (meth)acrylate, applying a pigment fixer containing a reaction agent to the resulting printed matter by an ink jet process, and heat-treating the printed matter that has been subjected to the application at a temperature of 110° C. to 200° C. for 1 minute or more.

The ink composition and the pigment fixer are the same as described above.

In the method for producing printed fabric according to the present invention, a heating temperature in the heat-treatment step of less than 110° C. does not result in improvement in the fixity of the printed fabric. A heating temperature exceeding 200° C. results in the degradation of fabric, the pigment, the polymer, and the like. The heating temperature is preferably in the range of 120° C. to 170° C. The heating time needs to be 1 minute or more. At a heating time of less than 1 minute, the reaction of the reaction agent, e.g., a block isocyanate, an oxazoline-containing polymer, or a polycarbodiimide, contained in the pigment fixer does not proceed sufficiently. The heating time is preferably 2 minutes or more.

A step of washing the printed matter with water or surfactant-containing water is preferably performed between the ink-jet printing step and the immersion step or the application step. An aqueous component in the ink can be washed away by the washing, thereby enhancing the fixity of the polymeric microparticles on the fabric to further improve the abrasion resistance of the printed fabric.

In the case where the ink composition is printed on fabric, the ink is preferably ejected by a method of using an electrostrictive element, such as a piezoelectric element, without generating heat. The reason for this is that if a thermal head which generates heat is used, the polymeric microparticles in the pigment fixer and the polymer used for, for example, the dispersion of the pigment in the ink deteriorate, so that the ejection tends to be unstable. In the case where like the production of printed fabric, a large amount of ink needs to be ejected over prolonged period of time in the step, a head that generates heat is not preferred.

### [Printed Fabric]

A printed fabric according to the present invention is obtained by the method for producing a printed fabric described above.

### EXAMPLES

While the present invention will be described in further detail below by means of examples and the like, the present invention is not limited to these examples. The terms “parts” and “%” used in compositions described in examples are used to indicate “parts by mass” and “% by mass”, respectively.

### Example A-1

### (1) Preparation of Ink Jet Recording Ink

An ink jet recording ink was prepared by mixing vehicle components shown in Table 2 with pigment dispersoid A1 and an aqueous polymeric microparticle dispersion (emulsion AA) prepared by methods described below. In each of this Example, other Examples, Comparative Examples, and Reference Examples of Example A series, ion-exchanged water (balance) in the ink contained 0.05% Topside 240 (manufactured by Permachem Asia, Ltd.) for preventing corrosion of the ink, 0.02% benzotriazole for preventing corrosion of ink jet head members, and 0.04% ethylenediaminetetraacetic acid disodium salt (EDTA•2Na) for reducing the effect of metal ions in the ink.

### Preparation of Pigment Dispersoid A1

Monarch 880 (manufactured by Cabot Corporation (USA)) serving as carbon black (Pigment Black 7) was used for Pigment dispersoid A1. Carbon black was subjected to surface oxidation so as to be dispersible in water by a method the same as in JP-A-8-3498, thereby affording dispersoid A1. The particle size was measured with Microtrac particle size distribution analyzer UPA250 (manufactured by Nikkiso Co., Ltd.) and found to be 110 nm.

### Preparation of Polymeric Microparticles

Ion-exchanged water (100 parts) was charged into a reaction vessel equipped with a dropping device, a thermometer, a water-cooled reflux condenser, and a stirrer. Potassium persulfate (0.2 parts) serving as a polymerization initiator was added thereto under stirring at 70° C. in a nitrogen atmosphere. A monomer solution of sodium lauryl sulfate (0.05 parts), glycidoxy acrylate (4 parts), ethyl acrylate (15 parts), butyl acrylate (15 parts), tetrahydrofurfuryl acrylate (6 parts), butyl methacrylate (5 parts), and t-dodecyl mercaptan (0.02 parts) in ion-exchanged water (7 parts) was added dropwise thereto at 70° C. to perform reaction, preparing a primary material. A 10% ammonium persulfate solution (2 parts) was added to the primary material, followed by stirring. A reaction mixture of ion-exchanged water (30 parts), potassium lauryl sulfate (0.2 parts), ethyl acrylate (30 parts), methyl acrylate (25 parts), butyl acrylate (6 parts), acrylic acid (5 parts), and t-dodecyl mercaptan (0.5 parts) was added thereto at 70° C. under stirring to perform polymerization reaction. The mixture was neutralized with sodium hydroxide. The pH was adjusted to 8 to 8.5. The mixture was filtered through a 0.3-μm filter to prepare an aqueous polymeric microparticle dispersion. The resulting dispersion was referred to as emulsion AA (EM-AA). After part of the aqueous polymeric microparticle dispersion was dried, the glass transition temperature was measured with a differential scanning calorimeter (EXSTAR 6000DSC, manufactured by Seiko Instruments Inc.) and found to be −15° C. The molecular weight in terms of styrene using THF as a solvent was measured by gel permeation chromatography (GPC) of L7100 System (manufactured by Hitachi, Ltd.) and found to be 150,000. The acid value was measured by a titration method and found to be 20 mg KOH/g.

### (2) Preparation of Pigment Fixer

A pigment fixer was prepared by mixing a block isocyanate (NK Linker BX, manufactured by Shin-Nakamura Chemical Co., Ltd.) with vehicle components shown in Table 3. Ion-exchanged water (balance) in each of the pigment fixers in this Example, other Examples, Comparative Examples, and Reference Examples of Example A series contained 0.05% Topside 240 (manufactured by Permachem Asia, Ltd.) for preventing corrosion of the ink, 0.02% benzotriazole for preventing corrosion of ink jet head members, and 0.04% ethylenediaminetetraacetic acid disodium salt (EDTA•2Na) for reducing the effect of metal ions in the ink.

### (3) Method for Producing Printed Fabric

A solid pattern was printed on a cotton fabric with the ink described above using an ink jet printer (PX-V600, manufactured by Seiko Epson Corporation) to form printed matter. Then a solid pattern was printed on the printed matter with the printer using the pigment fixer described above and subjected to heat treatment at 150° C. for 5 minutes to afford a printed fabric sample.

### (4) Abrasion Resistance Test and Dry-Cleaning Test

The sample (printed fabric) described above was subjected to an abrasion test with a Japan Society for the Promotion of Science-type color fastness rubbing tester (AB-301S, manufactured by Tester Sangyo Co., Ltd). In this test, the sample was rubbed 200 times under a load of 300 g. The degree of detachment of the ink was evaluated according to Japanese Industrial Standards (JIS) L0849 under two conditions: wet and dry. Similarly, a dry-cleaning test was performed according to Method B of JIS L0860. Table 1 shows the results of the abrasion resistance test and the dry-cleaning resistance test.

### (5) Measurement of Ejection Stability

Printing was performed on 100 pages of A4-size paper (Grade P, manufactured by Fuji Xerox Co., Ltd.) with the ink jet recording ink composition using an ink jet printer (PX-V600, manufactured by Seiko Epson Corporation) in an atmosphere maintained at 35° C. and 35% with Microsoft Word (manufactured by Microsoft Corporation) under the following conditions: font size: 11, format: standard, font type: MSP Gothic, and density: 4,000 characters per page, thereby evaluating the ejection stability. Evaluation criteria were as follows: AA: No print defect was observed, A: One print defect was observed, B: Two or three print defects were observed, C: Four or five print defects were observed, and D: Six or more print defects were observed. Table 1 shows the results.

### Example A-2

### (1) Preparation of Ink Jet Recording Ink

An ink jet recording ink was prepared by mixing vehicle components shown in Table 2 with pigment dispersoid A2 and an aqueous polymeric microparticle dispersion (emulsion AB) prepared by methods described below.

### Preparation of Pigment Dispersoid A2

Pigment Blue 15:3 (copper phthalocyanine pigment, manufactured by Clariant) was used for pigment dispersoid A2. After an atmosphere in a reaction vessel equipped with a stirrer, a thermometer, a reflux condenser, and a dripping funnel was replaced with nitrogen, benzyl acrylate (75 parts), acrylic acid (2 parts), and t-dodecyl mercaptan (0.3 parts) were charged into the vessel, followed by heating to 70° C. Benzyl acrylate (150 parts), acrylic acid (15 parts), butyl acrylate (5 parts), t-dodecyl mercaptan (1 part), methyl ethyl ketone (20 parts), and sodium persulfate (1 part) were separately provided and charged into the dropping funnel. The mixture was added dropwise to the reaction vessel over a period of 4 hours to perform polymerization reaction, thereby affording a dispersion polymer. Then methyl ethyl ketone was added to the reaction vessel to form a 40% dispersion polymer solution. After part of the polymer was dried, the glass transition temperature was measured with a differential scanning calorimeter (EXSTAR 6000DSC, manufactured by Seiko Instruments Inc.) and found to be 40° C.

The dispersion polymer solution (40 parts), Pigment Blue 15:3 (30 parts), a 0.1 mol/L sodium hydroxide aqueous solution (100 parts), and methyl ethyl ketone (30 parts) were mixed. The mixture was homogenized by 15 passes through an ultrahigh-pressure homogenizer (Ultimizer HJP-25005, manufactured by Sugino Machine Limited) at 200 MPa. The resulting mixture was transferred into another vessel. Ion-exchanged water (300 parts) was added thereto, followed by stirring for 1 hour. The total amount of methyl ethyl ketone and part of water were removed with a rotary evaporator. The mixture was neutralized with a 0.1 mol/L sodium hydroxide aqueous solution. The pH was adjusted to 9. The mixture was filtered through a 0.3-μm membrane filter. The filtered mixture was adjusted with ion-exchanged water to form pigment dispersoid A2 having a pigment concentration of 15%. The particle size was measured as in Example A-1 and found to be 80 nm.

### Preparation of Polymeric Microparticles

Ion-exchanged water (100 parts) was charged into a reaction vessel equipped with a dropping device, a thermometer, a water-cooled reflux condenser, and a stirrer. Potassium persulfate (0.2 parts) serving as a polymerization initiator was added thereto under stirring at 70° C. in a nitrogen atmosphere. A monomer solution of sodium lauryl sulfate (0.05 parts), ethyl acrylate (19 parts), butyl acrylate (15 parts), tetrahydrofurfuryl acrylate (6 parts), butyl methacrylate (5 parts), and t-dodecyl mercaptan (0.02 parts) in ion-exchanged water (7 parts) was added dropwise thereto at 70° C. to perform reaction, preparing a primary material. A 10% ammonium persulfate solution (2 parts) was added to the primary material, followed by stirring. A reaction mixture of ion-exchanged water (30 parts), potassium lauryl sulfate (0.2 parts), ethyl acrylate (30 parts), methyl acrylate (25 parts), butyl acrylate (16 parts), acrylic acid (5 parts), and t-dodecyl mercaptan (0.5 parts) was added thereto at 70° C. under stirring to perform polymerization reaction. The mixture was neutralized with sodium hydroxide. The pH was adjusted to 8 to 8.5. The mixture was filtered through a 0.3-μm filter to prepare an aqueous polymeric microparticle dispersion. The resulting dispersion was referred to as emulsion AB (EM-AB). After part of the aqueous polymeric microparticle dispersion was dried, the glass transition temperature was measured with a differential scanning calorimeter (EXSTAR 6000DSC, manufactured by Seiko Instruments Inc.) and found to be −17° C. The molecular weight was measured as in Example A-1 and found to be 200,000. The acid value was measured by a titration method and found to be 20 mg KOH/g.

### (2) Preparation of Pigment Fixer

A pigment fixer was prepared by mixing a block isocyanate (NK Linker BX, manufactured by Shin-Nakamura Chemical Co., Ltd.) with vehicle components shown in Table 3.

### (3) Method for Producing Printed Fabric

A printed fabric sample was produced as in Example A-1, except that the ink and the pigment fixer prepared in Example A-2 were used.

### (4) Abrasion Resistance Test and Dry-Cleaning Test

The sample (printed fabric) described above was subjected to an abrasion test and a dry-cleaning test as in Example A-1. Table 1 shows the results.

### (5) Measurement of Ejection Stability

The ejection stability was measured by the same method and evaluation method as in Example A-1, except that the ink prepared in Example A-2 was used. Table 1 shows the measurement results of the ejection stability.

### Example A-3

### (1) Preparation of Ink Jet Recording Ink

An ink jet recording ink was prepared by mixing vehicle components shown in Table 2 with pigment dispersoid A3 prepared by a method described below and emulsion AB prepared in Example A-2.

### Preparation of Pigment Dispersoid A3

Pigment dispersoid A3 was prepared in the same way as pigment dispersoid A2, except that Pigment Violet 19 (quinacridone pigment, manufactured by Clariant) was used. The particle size was measured as in Example A-1 and found to be 90 nm.

### (2) Preparation of Pigment Fixer

A pigment fixer was prepared by mixing a block isocyanate (NK Linker BX, manufactured by Shin-Nakamura Chemical Co., Ltd.) with vehicle components shown in Table 3.

### (3) Method for Producing Printed Fabric

A printed fabric sample was produced as in Example A-1, except that the ink and the pigment fixer prepared in Example A-3 were used.

### (4) Abrasion Resistance Test and Dry-Cleaning Test

The sample (printed fabric) described above was subjected to an abrasion test and a dry-cleaning test as in Example A-1. Table 1 shows the results.

### (5) Measurement of Ejection Stability

The ejection stability was measured by the same method and evaluation method as in Example A-1, except that the ink prepared in Example A-3 was used. Table 1 shows the measurement results of the ejection stability.

### Example A-4

### (1) Preparation of Ink Jet Recording Ink

An ink jet recording ink was prepared by mixing vehicle components shown in Table 2 with pigment dispersoid A4 prepared by a method described below and emulsion AB prepared in Example A-2.

### Preparation of Pigment Dispersoid A4

Pigment dispersoid A4 was prepared in the same way as pigment dispersoid A2, except that Pigment Yellow 14 (azo-based pigment, manufactured by Clariant) was used. The particle size was measured as in Example A-1 and found to be 115 nm.

### (2) Preparation of Pigment Fixer

A pigment fixer was prepared by mixing a block isocyanate (NK Linker BX, manufactured by Shin-Nakamura Chemical Co., Ltd.) with vehicle components shown in Table 3.

### (3) Method for Producing Printed Fabric

A printed fabric sample was produced as in Example A-1, except that the ink and the pigment fixer prepared in Example A-4 were used.

### (4) Abrasion Resistance Test and Dry-Cleaning Test

The sample (printed fabric) described above was subjected to an abrasion test and a dry-cleaning test as in Example A-1. Table 1 shows the results.

### (5) Measurement of Ejection Stability

The ejection stability was measured by the same method and evaluation method as in Example A-1, except that the ink prepared in Example A-4 was used. Table 1 shows the measurement results of the ejection stability.

### Comparative Example A-1

In Comparative Example A-1, an ink was prepared as in Example A-1, except that polymeric microparticles having a glass transition temperature of 0° C. were used, the polymeric microparticles being prepared in the same way as the ink in Example A-1, except that benzyl methacrylate (45 parts) was used in place of the total amount of ethyl acrylate (45 parts). An emulsion prepared using the polymeric microparticles was referred to as emulsion AC (EM-AC). Table 2 shows the ink composition. A pigment fixer was prepared by mixing a block isocyanate (NK Linker BX, manufactured by Shin-Nakamura Chemical Co., Ltd.) with vehicle components shown in Table 3. The production of a printed fabric sample, an abrasion resistance test, a dry-cleaning test, and an ejection stability test were performed as in Example A-1. Table 1 shows the results.

### Comparative Example A-2

In Comparative Example A-2, an ink was prepared as in Example A-2, except that polymeric microparticles having a glass transition temperature of 10° C. were used, the polymeric microparticles being prepared in the same way as the ink in Example A-2, except that benzyl methacrylate was used in place of the total amount of ethyl acrylate (49 parts) and that benzyl methacrylate (10 parts) was used in place of butyl acrylate (10 parts). An emulsion prepared using the polymeric microparticles was referred to as emulsion AD (EM-AD). Table 2 shows the ink composition. A pigment fixer was prepared by mixing a block isocyanate (NK Linker BX, manufactured by Shin-Nakamura Chemical Co., Ltd.) with vehicle components shown in Table 3. The production of a printed fabric sample, an abrasion resistance test, a dry-cleaning test, and an ejection stability test were performed as in Example A-1. Table 1 shows the results.

### Reference Example A-3

In Reference Example A-3, inks were prepared as in Example A-3, except that a pigment dispersoid having a particle size of 350 nm and a pigment dispersoid having a particle size of 45 nm were prepared. The particle size was measured by the same method as in Example A-1. The dispersoid having a particle size of 350 nm was referred to as pigment dispersoid A3A. The dispersoid having a particle size of 45 nm was referred to as pigment dispersoid A3B. Table 2 shows the ink compositions. A pigment fixer was prepared by mixing a block isocyanate (NK Linker BX, manufactured by Shin-Nakamura Chemical Co., Ltd.) with vehicle components shown in Table 3. The production of a printed fabric sample, an abrasion resistance test, a dry-cleaning test, and an ejection stability test were performed as in Example A-1. Table 1 shows the results.

### Comparative Example A-4

In Comparative Example A-4, inks were prepared as in Example A-4, except that polymeric microparticles having an acid value of 120 mg KOH/g and polymeric microparticles having an acid value of 150 mg KOH/g were prepared. An emulsion prepared using the polymeric microparticles having an acid value of 120 mg KOH/g was referred to as emulsion AE (EM-AE). An emulsion prepared using the polymeric microparticles having an acid value of 150 mg KOH/g was referred to as emulsion AF (EM-AF). Table 2 shows the ink compositions. A pigment fixer was prepared by mixing a block isocyanate (NK Linker BX, manufactured by Shin-Nakamura Chemical Co., Ltd.) with vehicle components shown in Table 3. The production of a printed fabric sample, an abrasion resistance test, a dry-cleaning test, and an ejection stability test were performed as in Example A-1. Table 1 shows the results.

### Comparative Example A-5

In Comparative Example A-5, a pigment fixer was prepared as in Example A-2, except that the block isocyanate (NK Linker BX, manufactured by Shin-Nakamura Chemical Co., Ltd.) was not used. Table 3 shows the composition of the pigment fixer. The same ink as in Example A-2 was used. Table 2 shows the ink composition. The production of a printed fabric sample, an abrasion resistance test, a dry-cleaning test, and an ejection stability test were performed as in Example A-1. Table 1 shows the results.

### Comparative Example A-6

In Comparative Example A-6, a pigment fixer was prepared as in Example A-3, except that the block isocyanate (NK Linker BX, manufactured by Shin-Nakamura Chemical Co., Ltd.) was not used. Table 3 shows the composition of the pigment fixer. The same ink as in Example A-3 was used. Table 2 shows the ink composition. The production of a printed fabric sample, an abrasion resistance test, a dry-cleaning test, and an ejection stability test were performed as in Example A-1. Table 1 shows the results.

TABLE 1
Result of abrasion resistance, dry-cleaning resistance, and ejection stability in Examples
A-1 to 4, Comparative Examples A-1, 2, and 4 to 6, and Reference Example A-3

| | | | | Abrasion | | | |
|---|---|---|---|---|---|---|---|
| | | Particle | | resistance | | Dry-cleaning | Ejection |
| | Tg | size | Acid value | Dry | Wet | resistance | stability |
| Example A-1 | −15 | 110 | 20 | ¾ | ¾ | ⅘ | A |
| Example A-2 | −17 | 80 | 20 | 5 | ⅘ | 5 | A |
| Example A-3 | −17 | 90 | 20 | 5 | 5 | 5 | A |
| Example A-4 | −17 | 115 | 20 | 5 | 5 | 5 | A |
| Comparative Example A-1 | 0 | 110 | 20 | 3 | 2 | ⅔ | A |
| Comparative Example A-2 | 10 | 80 | 20 | ⅔ | ⅔ | 2 | A |
| Reference Example A-3 | −17 | 350 | 20 | 2 | 2 | ⅔ | D |
| | −17 | 45 | 20 | ¾ | ¾ | 4 | C |
| Comparative Example A-4 | −17 | 115 | 120 | 3 | 3 | 3 | A |
| | −17 | 115 | 150 | ⅔ | ⅔ | ¾ | B |
| Comparative Example A-5 | −17 | 80 | 20 | 2 | ½ | 5 | A |
| Comparative Example A-6 | −17 | 90 | 20 | 3 | ⅔ | 5 | A |

The unit of Tg is ° C. The particle size indicates the average particle size of the pigment, and the unit thereof is nm. The unit of the acid value is mg KOH/g.
The abrasion resistance and dry-cleaning resistance are evaluated according to JIS.

TABLE 2
Ink composition (mass %) in Examples A-1 to 4, Comparative Examples A-1, 2, and 4 to 6, and
Reference Example A-3

| | | | | | Comparative | | Reference | | | | | |
|---|---|---|---|---|---|---|---|---|---|---|---|---|
| | Example | | | | Example | | Example | | Comparative Example | | | |
| | A-1 | A-2 | A-3 | A-4 | A-1 | A-2 | A-3 | | A-4 | | A-5 | A-6 |
| Dispersoid A1 | 4.5 | — | — | — | 4.5 | — | — | — | — | — | — | — |
| Dispersoid A2 | — | 3.5 | — | — | — | 3.5 | — | — | — | — | 3.5 | — |
| Dispersoid A3 | — | — | 4.5 | — | — | — | — | — | — | — | — | 4.5 |
| Dispersoid A4 | — | — | — | 4.5 | — | — | — | — | 4.5 | 4.5 | — | — |
| Dispersoid | — | — | — | — | — | — | 4.5 | — | — | — | — | — |
| A3A | | | | | | | | | | | | |
| Dispersoid | — | — | — | — | — | — | — | 4.5 | — | — | — | — |
| A3B | | | | | | | | | | | | |
| EM-AA | 6.0 | — | — | — | — | — | — | — | — | — | — | — |
| EM-AB | — | 5.0 | 6.0 | 6.0 | — | — | 6.0 | 6.0 | — | — | 5.0 | 6.0 |
| EM-AC | — | — | — | — | 6.0 | — | — | — | — | — | — | — |
| EM-AD | — | — | — | — | — | 6.0 | — | — | — | — | — | — |
| EM-AE | — | — | — | — | — | — | — | — | 6.0 | — | — | — |
| EM-AF | — | — | — | — | — | — | — | — | — | 6.0 | — | — |
| 1,2-HD | 2.0 | 3.0 | 3.0 | 2.0 | 2.0 | 3.0 | 3.0 | 3.0 | 2.0 | 2.0 | 3.0 | 3.0 |
| 1,2-PD | — | — | — | 1.0 | — | — | — | — | 1.0 | 1.0 | — | — |
| TEGmBE | 2.0 | 1.0 | 1.0 | 2.0 | 2.0 | 1.0 | 1.0 | 1.0 | 2.0 | 2.0 | 1.0 | 1.0 |
| S-104 | 0.3 | 0.3 | 0.3 | 0.3 | 0.3 | 0.3 | 0.3 | 0.3 | 0.3 | 0.3 | 0.3 | 0.3 |
| S-465 | 0.5 | 0.5 | 0.3 | 0.5 | 0.5 | 0.5 | 0.3 | 0.3 | 0.5 | 0.5 | 0.5 | 0.3 |
| S-61 | — | — | 0.2 | — | — | — | 0.2 | 0.2 | — | — | — | 0.2 |
| Glycerol | 10.0 | 12.0 | 10.0 | 10.0 | 10.0 | 12.0 | 10.0 | 10.0 | 10.0 | 10.0 | 12.0 | 10.0 |
| TMP | 3.0 | 3.0 | 3.0 | 3.0 | 3.0 | 3.0 | 3.0 | 3.0 | 3.0 | 3.0 | 3.0 | 3.0 |
| TEG | 3.0 | 5.0 | 4.0 | 4.0 | 4.0 | 4.0 | 4.0 | 4.0 | 4.0 | 4.0 | 5.0 | 4.0 |
| 2-P | 1.0 | — | — | — | 1.0 | — | — | — | — | — | — | — |
| TEA | 1.0 | 1.0 | 1.0 | 1.0 | 1.0 | 1.0 | 1.0 | 1.0 | 1.0 | 1.0 | 1.0 | 1.0 |
| Ion exchanged | Balance | Balance | Balance | Balance | Balance | Balance | Balance | Balance | Balance | Balance | Balance | Balance |
| water | | | | | | | | | | | | |

The concentrations of pigments and polymers are expressed in terms of solid contents
1,2-HD 1,2-Hexanediol
1,2-PD 1,2-Pentanediol
TEGmBE Triethylene glycol monobutyl ether
S-104 Surfynol 104 (acetylenic glycol-based surfactant, manufactured by Nissin Chemical Industry Co., Ltd.)
S-465 Surfynol 465 (acetylenic glycol-based surfactant, manufactured by Nissin Chemical Industry Co., Ltd.)
S-61 Surfynol 61 (acetylenic alcohol-based surfactant, manufactured by Nissin Chemical Industry Co., Ltd.)
TMP Trimethylolpropane
TEG Triethylene glycol
2-P 2-Pyrrolidone
TEA Triethanolamine

TABLE 3
Composition (mass %) of pigment fixing solution in Examples A-1 to 4,
Comparative Examples A-1, 2, and 4 to 6, and Reference Example A-3

| | | | | | Comparative | | | | Reference | | | |
|---|---|---|---|---|---|---|---|---|---|---|---|---|
| | Example | | | | Example | | Example | | Comparative Example | | | |
| | A-1 | A-2 | A-3 | A-4 | A-1 | A-2 | A-3 | | A-4 | | A-5 | A-6 |
| NKLinkerBX | 2.0 | 3.0 | 3.0 | 2.0 | 2.0 | 3.0 | 3.0 | 3.0 | 2.0 | 2.0 | — | — |
| 1,2-HD | 2.0 | 3.0 | 3.0 | 2.0 | 2.0 | 3.0 | 3.0 | 3.0 | 2.0 | 2.0 | 3.0 | 3.0 |
| 1,2-PD | — | — | — | 1.0 | — | — | — | — | 1.0 | 1.0 | — | — |
| TEGmBE | 2.0 | 1.0 | 1.0 | 2.0 | 2.0 | 1.0 | 1.0 | 1.0 | 2.0 | 2.0 | 1.0 | 1.0 |
| S-104 | 0.3 | 0.3 | 0.3 | 0.3 | 0.3 | 0.3 | 0.3 | 0.3 | 0.3 | 0.3 | 0.3 | 0.3 |
| S-465 | 0.5 | 0.5 | 0.3 | 0.5 | 0.5 | 0.5 | 0.3 | 0.3 | 0.5 | 0.5 | 0.5 | 0.3 |
| S-61 | — | — | 0.2 | — | — | — | 0.2 | 0.2 | — | — | — | 0.2 |
| Glycerol | 10.0 | 12.0 | 10.0 | 10.0 | 10.0 | 12.0 | 10.0 | 10.0 | 10.0 | 10.0 | 12.0 | 10.0 |
| TMP | 3.0 | 3.0 | 3.0 | 3.0 | 3.0 | 3.0 | 3.0 | 3.0 | 3.0 | 3.0 | 3.0 | 3.0 |
| TEG | 3.0 | 5.0 | 4.0 | 4.0 | 4.0 | 4.0 | 4.0 | 4.0 | 4.0 | 4.0 | 5.0 | 4.0 |
| 2-P | 1.0 | — | — | — | 1.0 | — | — | — | — | — | — | — |
| TEA | 1.0 | 1.0 | 1.0 | 1.0 | 1.0 | 1.0 | 1.0 | 1.0 | 1.0 | 1.0 | 1.0 | 1.0 |
| Ion exchanged | Balance | Balance | Balance | Balance | Balance | Balance | Balance | Balance | Balance | Balance | Balance | Balance |
| water | | | | | | | | | | | | |

The polymer concentration is expressed in terms of a solid content.
NKLinkerBX Block isocyanate emulsion manufactured by Shin-Nakamura Chemical Co., Ltd.
1,2-HD 1,2-Hexanediol
1,2-PD 1,2-Pentanediol
TEGmBE Triethylene glycol monobutyl ether
S-104 Surfynol 104 (acetylenic glycol-based surfactant, manufactured by Nissin Chemical Industry Co., Ltd.)
S-465 Surfynol 465 (acetylenic glycol-based surfactant, manufactured by Nissin Chemical Industry Co., Ltd.)
S-61 Surfynol 61 (acetylenic alcohol-based surfactant, manufactured by Nissin Chemical Industry Co., Ltd.)
TMP Trimethylolpropane
TEG Triethylene glycol
2-P 2-Pyrrolidone
TEA Triethanolamine

### Example A-5

### (1) Preparation of Ink Jet Recording Ink

An ink jet recording ink was prepared by mixing vehicle components shown in Table 5 with pigment dispersoid A5 and an aqueous polymeric microparticle dispersion (emulsion AI) prepared by methods described below.

### Preparation of Pigment Dispersoid A5

MA100 (manufactured by Mitsubishi Chemical Industries Ltd.) serving as carbon black (PBk7) was used for pigment dispersoid A5. Carbon black was subjected to surface oxidation so as to be dispersible in water by a method the same as in JP-A-8-3498, thereby affording dispersoid A5. The particle size was measured as in Example A-1 and found to be 120 nm.

### Preparation of Polymeric Microparticles

Ion-exchanged water (100 parts) was charged into a reaction vessel equipped with a dropping device, a thermometer, a water-cooled reflux condenser, and a stirrer. Potassium persulfate (0.3 parts) serving as a polymerization initiator was added thereto under stirring at 70° C. in a nitrogen atmosphere. A monomer solution of sodium lauryl sulfate (0.05 parts), ethyl acrylate (20 parts), butyl acrylate (15 parts), lauryl acrylate (6 parts), butyl methacrylate (5 parts), and t-dodecyl mercaptan (0.02 parts) in ion-exchanged water (7 parts) was added dropwise thereto at 70° C. to perform reaction, preparing a primary material. A 10% ammonium persulfate solution (2 parts) was added to the primary material, followed by stirring. A reaction mixture of ion-exchanged water (30 parts), potassium lauryl sulfate (0.2 parts), ethyl acrylate (30 parts), butyl acrylate (25 parts), lauryl acrylate (16 parts), acrylic acid (5 parts), and t-dodecyl mercaptan (0.5 parts) was added thereto at 70° C. under stirring to perform polymerization reaction. The mixture was neutralized with sodium hydroxide. The pH was adjusted to 8 to 8.5. The mixture was filtered through a 0.3-μm filter to prepare an aqueous polymeric microparticle dispersion. The resulting dispersion was referred to as emulsion AI (EM-AI). After part of the aqueous polymeric microparticle dispersion was dried, the glass transition temperature was measured with a differential scanning calorimeter (EXSTAR 6000DSC, manufactured by Seiko Instruments Inc.) and found to be −19° C. The molecular weight was measured as in Example A-1 and found to be 180,000. The acid value was measured by a titration method and found to be 18 mg KOH/g.

### (2) Preparation of Pigment Fixer

A pigment fixer was prepared by mixing a block isocyanate (NK Linker BX, manufactured by Shin-Nakamura Chemical Co., Ltd.) with vehicle components shown in Table 6.

### (3) Method for Producing Printed Fabric

A printed fabric sample was produced as in Example A-1, except that the ink and the pigment fixer prepared in Example A-5 were used.

### (4) Abrasion Resistance Test and Dry-Cleaning Test

The sample (printed fabric) described above was subjected to an abrasion test and a dry-cleaning test as in Example A-1. Table 4 shows the results.

### (5) Measurement of Ejection Stability

The ejection stability was measured by the same method and evaluation method as in Example A-1, except that the ink prepared in Example A-5 was used. Table 4 shows the measurement results of the ejection stability.

### Example A-6

### (1) Preparation of Ink Jet Recording Ink

An ink jet recording ink was prepared by mixing vehicle components shown in Table 5 with pigment dispersoid A6 and an aqueous polymeric microparticle dispersion (emulsion AJ) prepared by methods described below.

### Preparation of Pigment Dispersoid A6

Pigment Blue 15:3 (copper phthalocyanine pigment, manufactured by Clariant) was used for pigment dispersoid A6. After an atmosphere in a reaction vessel equipped with a stirrer, a thermometer, a reflux condenser, and a dripping funnel was replaced with nitrogen, styrene (45 parts), polyethylene glycol 400 acrylate (30 parts), benzyl acrylate (10 parts), acrylic acid (2 parts), and t-dodecyl mercaptan (0.3 parts) were charged into the vessel, followed by heating to 70° C. Styrene (150 parts), polyethylene glycol 400 acrylate (100 parts), acrylic acid (15 parts), butyl acrylate (5 parts), t-dodecyl mercaptan (1 part), and sodium persulfate (5 parts) were separately provided and charged into the dropping funnel. The mixture was added dropwise to the reaction vessel over a period of 4 hours to perform polymerization reaction, thereby affording a dispersion polymer. Then water was added to the reaction vessel to form a 40% dispersion polymer solution. After part of the polymer was dried, the glass transition temperature was measured with a differential scanning calorimeter (EXSTAR 6000DSC, manufactured by Seiko Instruments Inc.) and found to be 45° C.

The dispersion polymer solution (40 parts), Pigment Blue 15:3 (copper phthalocyanine pigment, manufactured by Clariant) (30 parts), and a 0.1 mol/L sodium hydroxide aqueous solution (100 parts) were mixed. The mixture was subjected to dispersion with an Eiger mill using zirconia beads for 2 hours. The resulting mixture was transferred into another vessel. Ion-exchanged water (300 parts) was added thereto, followed by stirring for 1 hour. The mixture was neutralized with 0.1 mol/L sodium hydroxide. The pH was adjusted to 9. The mixture was filtered through a 0.3-μm membrane filter to form pigment dispersoid A6 having a solid content (the dispersion polymer and Pigment Blue 15:3) of 20%. The particle size was measured as in Example A-1 and found to be 100 nm. The molecular weight was measured and found to be 210,000.

### Preparation of Polymeric Microparticles

Ion-exchanged water (100 parts) was charged into a reaction vessel equipped with a dropping device, a thermometer, a water-cooled reflux condenser, and a stirrer. Potassium persulfate (0.3 parts) serving as a polymerization initiator was added thereto under stirring at 70° C. in a nitrogen atmosphere. A monomer solution of sodium lauryl sulfate (0.05 parts), ethyl acrylate (20 parts), butyl acrylate (25 parts), lauryl acrylate (6 parts), butyl methacrylate (5 parts), and t-dodecyl mercaptan (0.02 parts) in ion-exchanged water (7 parts) was dropwise thereto at 70° C. to perform reaction, preparing a primary material. A 10% ammonium persulfate solution (2 parts) was added to the primary material, followed by stirring. A reaction mixture of ion-exchanged water (30 parts), potassium lauryl sulfate (0.2 parts), ethyl acrylate (20 parts), butyl acrylate (20 parts), lauryl acrylate (20 parts), acrylic acid (5 parts), and t-dodecyl mercaptan (0.5 parts) was added thereto at 70° C. under stirring to perform polymerization reaction. The mixture was neutralized with sodium hydroxide. The pH was adjusted to 8 to 8.5. The mixture was filtered through a 0.3-μm filter to prepare an aqueous polymeric microparticle dispersion. The resulting dispersion was referred to as emulsion AJ (EM-AJ). After part of the aqueous polymeric microparticle dispersion was dried, the glass transition temperature was measured with a differential scanning calorimeter (EXSTAR 6000DSC, manufactured by Seiko Instruments Inc.) and found to be −21° C. The acid value was measured by a titration method and found to be 18 mg KOH/g.

### (2) Preparation of Pigment Fixer

A pigment fixer was prepared by mixing a block isocyanate (NK Linker BX, manufactured by Shin-Nakamura Chemical Co., Ltd.) with vehicle components shown in Table 6.

### (3) Method for Producing Printed Fabric

A printed fabric sample was produced as in Example A-1, except that the ink and the pigment fixer prepared in Example A-6 were used.

### (4) Abrasion Resistance Test and Dry-Cleaning Test

The sample (printed fabric) described above was subjected to an abrasion test and a dry-cleaning test as in Example A-1. Table 4 shows the results.

### (5) Measurement of Ejection Stability

The ejection stability was measured by the same method and evaluation method as in Example A-1, except that the ink prepared in Example A-6 was used. Table 4 shows the measurement results of the ejection stability.

### Example A-7

### (1) Preparation of Ink Jet Recording Ink

An ink jet recording ink was prepared by mixing vehicle components shown in Table 5 with pigment dispersoid A7 prepared by a method described below and emulsion AJ prepared in Example A-6.

### Preparation of Pigment Dispersoid A7

Pigment dispersoid A7 was prepared in the same way as pigment dispersoid A6, except that Pigment Red 122 (dimethyl quinacridone pigment, manufactured by Clariant) was used. The particle size was measured as in Example A-1 and found to be 80 nm.

### (2) Preparation of Pigment Fixer

A pigment fixer was prepared by mixing a block isocyanate (NK Linker BX, manufactured by Shin-Nakamura Chemical Co., Ltd.) with vehicle components shown in Table 6.

### (3) Method for Producing Printed Fabric

A printed fabric sample was produced as in Example A-1, except that the ink and the pigment fixer prepared in Example A-7 were used.

### (4) Abrasion Resistance Test and Dry-Cleaning Test

The sample (printed fabric) described above was subjected to an abrasion test and a dry-cleaning test as in Example A-1. Table 4 shows the results.

### (5) Measurement of Ejection Stability

The ejection stability was measured by the same method and evaluation method as in Example A-1, except that the ink prepared in Example A-7 was used. Table 4 shows the measurement results of the ejection stability.

### Example A-8

### (1) Preparation of Ink Jet Recording Ink

An ink jet recording ink was prepared by mixing vehicle components shown in Table 5 with pigment dispersoid A8 prepared by a method described below and emulsion AJ prepared in Example A-6.

### Preparation of Pigment Dispersoid A8

Pigment dispersoid A8 was prepared in the same way as pigment dispersoid A6, except that Pigment Yellow 180 (benzimidazolone-based disazo pigment, manufactured by Clariant) was used. The particle size was measured as in Example A-1 and found to be 130 nm.

### (2) Preparation of Pigment Fixer

A pigment fixer was prepared by mixing a block isocyanate (NK Linker BX, manufactured by Shin-Nakamura Chemical Co., Ltd.) with vehicle components shown in Table 6.

### (3) Method for Producing Printed Fabric

A printed fabric sample was produced as in Example A-1, except that the ink and the pigment fixer prepared in Example A-8 were used.

### (4) Abrasion Resistance Test and Dry-Cleaning Test

The sample (printed fabric) described above was subjected to an abrasion test and a dry-cleaning test as in Example A-1. Table 4 shows the results.

### (5) Measurement of Ejection Stability

The ejection stability was measured by the same method and evaluation method as in Example A-1, except that the ink prepared in Example A-8 was used. Table 4 shows the measurement results of the ejection stability.

### Reference Example A-7

In Reference Example A-7, inks were prepared as in Example A-5, except that polymeric microparticles having a molecular weight of 90,000 and polymeric microparticles having a molecular weight of 1,100,000 were used. An emulsion having a molecular weight of 90,000 was referred to as emulsion AK (EM-AK). An emulsion having a molecular weight of 1,100,000 was referred to as emulsion AL (EM-AL). Table 5 shows the ink compositions. A pigment fixer was prepared by mixing a block isocyanate (NK Linker BX, manufactured by Shin-Nakamura Chemical Co., Ltd.) with vehicle components shown in Table 6. The production of a printed fabric sample, an abrasion resistance test, a dry-cleaning test, and an ejection stability test were performed as in Example A-1. Table 4 shows the results.

### Reference Example A-8

In Reference Example A-8, an ink was prepared as in Example A-6, except that glycerol was used in place of 1,2-hexanediol in the ink in Example A-6. Table 5 shows the ink composition. A pigment fixer was prepared by mixing a block isocyanate (NK Linker BX, manufactured by Shin-Nakamura Chemical Co., Ltd.) with vehicle components shown in Table 6. The production of a printed fabric sample, an abrasion resistance test, a dry-cleaning test, and an ejection stability test were performed as in Example A-1. Table 4 shows the results.

### Reference Example A-9

In Reference Example A-9, an ink was prepared as in Example A-7, except that glycerol was used in place of the acetylenic glycol-based surfactant and the acetylenic alcohol-based surfactant in the ink in Example A-7. Table 5 shows the ink composition. A pigment fixer was prepared by mixing a block isocyanate (NK Linker BX, manufactured by Shin-Nakamura Chemical Co., Ltd.) with vehicle components shown in Table 6. The production of a printed fabric sample, an abrasion resistance test, a dry-cleaning test, and an ejection stability test were performed as in Example A-1. Table 4 shows the results.

### Reference Example A-10

In Reference Example A-10, inks were prepared as in Example A-8, except that the proportions of the polymeric microparticles in the inks were set at 80% and 50% with respect to the pigment. Table 5 shows the ink composition. A pigment fixer was prepared by mixing a block isocyanate (NK Linker BX, manufactured by Shin-Nakamura Chemical Co., Ltd.) with vehicle components shown in Table 6. The production of a printed fabric sample, an abrasion resistance test, a dry-cleaning test, and an ejection stability test were performed as in Example A-1. Table 4 shows the results.

### Reference Examples A-11 to 15

In Reference Examples A-11 to 15, solid patterns were printed on cotton fabrics by the method for producing a printed fabric in Example A-6 to form samples. The samples were subjected to heat treatment under various conditions different from the conditions in which heat treatment was performed at 150° C. for 5 minutes. The abrasion resistance was evaluated as in Example A-6. Reference Examples A-11 to 15 in which different heat treatment conditions were used were compared with Example A-6. Table 7 shows the results.

TABLE 4
Result of abrasion resistance, dry-cleaning resistance, and ejection stability in Examples
A-5 to 8 and Reference Examples A-7 to 10

| | | | | | Proportion | Abrasion | | | |
|---|---|---|---|---|---|---|---|---|---|
| | | Particle | Acid | Molecular | with respect | resistance | | Dry-cleaning | Ejection |
| | Tg | size | value | weight | to pigment | Dry | Wet | resistance | stability |
| Example A-5 | −19 | 120 | 18 | 1.8 | 120 | 4 | 4 | 5 | A |
| Example A-6 | −21 | 100 | 18 | 2.0 | 150 | 5 | 5 | 5 | A |
| Example A-7 | −21 | 80 | 18 | 2.0 | 100 | 5 | 5 | 5 | A |
| Example A-8 | −21 | 130 | 18 | 2.0 | 120 | 5 | 5 | 5 | A |
| Reference Example A-7 | −19 | 120 | 18 | 0.9 | 120 | 3 | 3 | 2 | A |
| | −19 | 120 | 18 | 11.0 | 120 | 3 | ⅔ | 3 | D |
| Reference Example A-8 | −21 | 100 | 18 | 2.0 | 150 | 5 | ⅘ | 5 | C |
| Reference Example A-9 | −21 | 80 | 18 | 2.0 | 100 | ⅘ | ⅘ | 5 | C |
| Reference Example A-10 | −21 | 130 | 18 | 2.0 | 80 | ¾ | ¾ | 3 | A |
| | −21 | 130 | 18 | 2.0 | 50 | ⅔ | ⅔ | 2 | A |

The unit of Tg is ° C. The particle size indicates the average particle size of the pigment, and the unit thereof is nm. The unit of the acid value is mg KOH/g.
In Table 4, the molecular weight × 10⁵ is a molecular weight.
The proportion of the polymer to the pigment is indicated by percent.
The abrasion resistance and dry-cleaning resistance are evaluated according to JIS.

TABLE 5
Ink composition (mass %) in Examples A-5 to 8 and Reference Examples A-7 to 10

| | Example | | | | Reference Example | | | | | |
|---|---|---|---|---|---|---|---|---|---|---|
| | A-5 | A-6 | A-7 | A-8 | A-7 | | A-8 | A-9 | A-10 | |
| Dispersoid A5 | 4.0 | — | — | — | 4.0 | 4.0 | — | — | — | — |
| Dispersoid A6 | — | 3.2 | — | — | — | — | 3.2 | — | — | — |
| Dispersoid A7 | — | — | 4.0 | — | — | — | — | 4.0 | — | — |
| Dispersoid A8 | — | — | — | 4.0 | — | — | — | — | 4.0 | 4.0 |
| EM-AI | 5.0 | — | — | — | — | — | — | — | — | — |
| EM-AJ | — | 4.8 | 4.0 | 5.0 | — | — | 4.8 | 4.0 | 3.2 | 2 |
| EM-AK | — | — | — | — | 5.0 | — | — | — | — | — |
| EM-AL | — | — | — | — | — | 5.0 | — | — | — | — |
| 1,2-HD | 2.0 | 3.0 | 3.0 | 2.0 | 2.0 | 2.0 | — | 3.0 | 2.0 | 2.0 |
| 1,2-PD | — | — | — | 1.0 | — | — | — | — | 1.0 | 1.0 |
| TEGmBE | 2.0 | 1.0 | 1.0 | 2.0 | 2.0 | 2.0 | 1.0 | 1.0 | 2.0 | 2.0 |
| S-104 | 0.3 | 0.3 | 0.3 | 0.3 | 0.3 | 0.3 | 0.3 | — | 0.3 | 0.3 |
| S-465 | 0.5 | 0.5 | 0.3 | 0.5 | 0.5 | 0.5 | 0.3 | — | 0.5 | 0.5 |
| S-61 | — | — | 0.2 | — | — | — | 0.2 | — | — | — |
| Glycerol | 10.0 | 12.0 | 10.0 | 10.0 | 10.0 | 12.0 | 13.0 | 11.0 | 10.0 | 10.0 |
| TMP | 3.0 | 3.0 | 3.0 | 3.0 | 3.0 | 3.0 | 3.0 | 3.0 | 3.0 | 3.0 |
| TEG | 3.0 | 5.0 | 4.0 | 4.0 | 4.0 | 4.0 | 4.0 | 4.0 | 4.0 | 4.0 |
| 2-P | 1.0 | — | — | — | 1.0 | — | — | — | — | — |
| TEA | 1.0 | 1.0 | 1.0 | 1.0 | 1.0 | 1.0 | 1.0 | 1.0 | 1.0 | 1.0 |
| Ion exchanged water | Balance | Balance | Balance | Balance | Balance | Balance | Balance | Balance | Balance | Balance |

The concentrations of pigments and polymers are expressed in terms of solid contents
1,2-HD 1,2-Hexanediol
1,2-PD 1,2-Pentanediol
TEGmBE Triethylene glycol monobutyl ether
S-104 Surfynol 104 (acetylenic glycol-based surfactant, manufactured by Nissin Chemical Industry Co., Ltd.)
S-465 Surfynol 465 (acetylenic glycol-based surfactant, manufactured by Nissin Chemical Industry Co., Ltd.)
S-61 Surfynol 61 (acetylenic alcohol-based surfactant, manufactured by Nissin Chemical Industry Co., Ltd.)
TMP Trimethylolpropane
TEG Triethylene glycol
2-P 2-Pyrrolidone
TEA Triethanolamine

TABLE 6
Composition (mass %) of pigment fixing solution in Examples A-5 to 8 and Reference Examples
A-7 to 10

| | Example | | | | Reference Example | | | | | |
|---|---|---|---|---|---|---|---|---|---|---|
| | A-5 | A-6 | A-7 | A-8 | A-7 | | A-8 | A-9 | A-10 | |
| NKLinkerBX | 2.0 | 3.0 | 3.0 | 2.0 | 2.0 | 2.0 | 3.0 | 3.0 | 2.0 | 2.0 |
| 1,2-HD | 2.0 | 3.0 | 3.0 | 2.0 | 2.0 | 2.0 | — | 3.0 | 2.0 | 2.0 |
| 1,2-PD | — | — | — | 1.0 | — | — | — | — | 1.0 | 1.0 |
| TEGmBE | 2.0 | 1.0 | 1.0 | 2.0 | 2.0 | 2.0 | 1.0 | 1.0 | 2.0 | 2.0 |
| S-104 | 0.3 | 0.3 | 0.3 | 0.3 | 0.3 | 0.3 | 0.3 | — | 0.3 | 0.3 |
| S-465 | 0.5 | 0.5 | 0.3 | 0.5 | 0.5 | 0.5 | 0.3 | — | 0.5 | 0.5 |
| S-61 | — | — | 0.2 | — | — | — | 0.2 | — | — | — |
| Glycerol | 10.0 | 12.0 | 10.0 | 10.0 | 10.0 | 12.0 | 13.0 | 11.0 | 10.0 | 10.0 |
| TMP | 3.0 | 3.0 | 3.0 | 3.0 | 3.0 | 3.0 | 3.0 | 3.0 | 3.0 | 3.0 |
| TEG | 3.0 | 5.0 | 4.0 | 4.0 | 4.0 | 4.0 | 4.0 | 4.0 | 4.0 | 4.0 |
| 2-P | 1.0 | — | — | — | 1.0 | — | — | — | — | — |
| TEA | 1.0 | 1.0 | 1.0 | 1.0 | 1.0 | 1.0 | 1.0 | 1.0 | 1.0 | 1.0 |
| Ion exchanged water | Balance | Balance | Balance | Balance | Balance | Balance | Balance | Balance | Balance | Balance |

The polymer concentration is expressed in terms of a solid content.
NKLinkerBX Block isocyanate emulsion manufactured by Shin-Nakamura Chemical Co., Ltd.
1,2-HD 1,2-Hexanediol
1,2-PD 1,2-Pentanediol
TEGmBE Triethylene glycol monobutyl ether
S-104 Surfynol 104 (acetylenic glycol-based surfactant, manufactured by Nissin Chemical Industry Co., Ltd.)
S-465 Surfynol 465 (acetylenic glycol-based surfactant, manufactured by Nissin Chemical Industry Co., Ltd.)
S-61 Surfynol 61 (acetylenic alcohol-based surfactant, manufactured by Nissin Chemical Industry Co., Ltd.)
TMP Trimethylolpropane
TEG Triethylene glycol
2-P 2-Pyrrolidone
TEA Triethanolamine

TABLE 7
Result of rubbing test in Example A-6 under various heating
conditions

| | | | Abrasion | | |
|---|---|---|---|---|---|
| | Temperature | Time | resistance | | |
| | (° C.) | (min) | Dry | Wet | State |
| Example A-6 | 150 | 5 | 5 | 5 | Good |
| Reference Example A-11 | 100 | 5 | 3 | 3 | Good |
| Reference Example A-12 | 150 | 0.5 | 3 | 3 | Good |
| Reference Example A-13 | 210 | 5 | 4 | 4 | Cloth |
| | | | | | yellowed |
| Reference Example A-14 | 210 | 1 | 4 | 4 | Cloth |
| | | | | | yellowed |
| Reference Example A-15 | 100 | 20 | 3 | 3 | Good |

### Example B-1

### (1) Preparation of Ink Jet Recording Ink

An ink jet recording ink was prepared by mixing vehicle components shown in Table 9 with pigment dispersoid B1 and an aqueous polymeric microparticle dispersion (emulsion BA) prepared by methods described below. In each of this Example, other Examples, Comparative Examples, and Reference Examples of Example B series, ion-exchanged water (balance) in the ink contained 0.05% Topside 240 (manufactured by Permachem Asia, Ltd.) for preventing corrosion of the ink, 0.02% benzotriazole for preventing corrosion of ink jet head members, and 0.04% ethylenediaminetetraacetic acid disodium salt (EDTA•2Na) for reducing the effect of metal ions in the ink.

### Preparation of Pigment Dispersoid B1

Monarch 880 (manufactured by Cabot Corporation (USA)) serving as carbon black (Pigment Black 7) was used for Pigment dispersoid B1. Carbon black was subjected to surface oxidation so as to be dispersible in water by a method the same as in JP-A-8-3498, thereby affording dispersoid B1. The particle size was measured with Microtrac particle size distribution analyzer UPA250 (manufactured by Nikkiso Co., Ltd.) and found to be 110 nm.

### Preparation of Polymeric Microparticles

Ion-exchanged water (100 parts) was charged into a reaction vessel equipped with a dropping device, a thermometer, a water-cooled reflux condenser, and a stirrer. Potassium persulfate (0.2 parts) serving as a polymerization initiator was added thereto under stirring at 70° C. in a nitrogen atmosphere. A monomer solution of sodium lauryl sulfate (0.05 parts), glycidoxy acrylate (4 parts), ethyl acrylate (15 parts), butyl acrylate (15 parts), tetrahydrofurfuryl acrylate (6 parts), butyl methacrylate (5 parts), and t-dodecyl mercaptan (0.02 parts) in ion-exchanged water (7 parts) was added dropwise thereto at 70° C. to perform reaction, preparing a primary material. A 10% ammonium persulfate solution (2 parts) was added to the primary material, followed by stirring. A reaction mixture of ion-exchanged water (30 parts), potassium lauryl sulfate (0.2 parts), ethyl acrylate (30 parts), methyl acrylate (25 parts), butyl acrylate (6 parts), acrylic acid (5 parts), and t-dodecyl mercaptan (0.5 parts) was added thereto at 70° C. under stirring to perform polymerization reaction. The mixture was neutralized with sodium hydroxide. The pH was adjusted to 8 to 8.5. The mixture was filtered through a 0.3-μm filter to prepare an aqueous polymeric microparticle dispersion. The resulting dispersion was referred to as emulsion BA (EM-BA). After part of the aqueous polymeric microparticle dispersion was dried, the glass transition temperature was measured with a differential scanning calorimeter (EXSTAR 6000DSC, manufactured by Seiko Instruments Inc.) and found to be −15° C. The molecular weight in terms of styrene using THF as a solvent was measured by gel permeation chromatography (GPC) of L7100 System (manufactured by Hitachi, Ltd.) and found to be 150,000. The acid value was measured by a titration method and found to be 20 mg KOH/g.

### (2) Preparation of Pigment Fixer

A pigment fixer was prepared by mixing an oxazoline-containing polymer (NK Linker FX, manufactured by Shin-Nakamura Chemical Co., Ltd.) with vehicle components shown in Table 10. Ion-exchanged water (balance) in each of the pigment fixers in this Example, other Examples, Comparative Examples, and Reference Examples of Example B series contained 0.05% Topside 240 (manufactured by Permachem Asia, Ltd.) for preventing corrosion of the ink, 0.02% benzotriazole for preventing corrosion of ink jet head members, and 0.04% ethylenediaminetetraacetic acid disodium salt (EDTA•2Na) for reducing the effect of metal ions in the ink.

### (3) Method for Producing Printed Fabric

A solid pattern was printed on a cotton fabric with the ink described above using an ink jet printer (PX-V600, manufactured by Seiko Epson Corporation) to form printed matter. Then a solid pattern was printed on the printed matter with the printer using the pigment fixer described above and subjected to heat treatment at 150° C. for 5 minutes to afford a printed fabric sample.

### (4) Abrasion Resistance Test and Dry-Cleaning Test

The sample (printed fabric) described above was subjected to an abrasion test with a Japan Society for the Promotion of Science-type color fastness rubbing tester (AB-301S, manufactured by Tester Sangyo Co., Ltd). In this test, the sample was rubbed 200 times under a load of 300 g. The degree of detachment of the ink was evaluated according to Japanese Industrial Standards (JIS) L0849 under two conditions: wet and dry. Similarly, a dry-cleaning test was performed according to Method B of JIS L0860. Table 8 shows the results of the abrasion resistance test and the dry-cleaning resistance test.

### (5) Measurement of Ejection Stability

Printing was performed on 100 pages of A4-size paper (Grade P, manufactured by Fuji Xerox Co., Ltd.) with the ink jet recording ink composition using an ink jet printer (PX-V600, manufactured by Seiko Epson Corporation) in an atmosphere maintained at 35° C. and 35% with Microsoft Word (manufactured by Microsoft Corporation) under the following conditions: font size: 11, format: standard, font type: MSP Gothic, and density: 4,000 characters per page, thereby evaluating the ejection stability. Evaluation criteria were as follows: AA: No print defect was observed, A: One print defect was observed, B: Two or three print defects were observed, C: Four or five print defects were observed, and D: Six or more print defects were observed. Table 8 shows the results.

### Example B-2

### (1) Preparation of Ink Jet Recording Ink

An ink jet recording ink was prepared by mixing vehicle components shown in Table 9 with pigment dispersoid B2 and an aqueous polymeric microparticle dispersion (emulsion BB) prepared by methods described below.

### Preparation of Pigment Dispersoid B2

Pigment Blue 15:3 (copper phthalocyanine pigment, manufactured by Clariant) was used for pigment dispersoid B2. After an atmosphere in a reaction vessel equipped with a stirrer, a thermometer, a reflux condenser, and a dripping funnel was replaced with nitrogen, benzyl acrylate (75 parts), acrylic acid (2 parts), and t-dodecyl mercaptan (0.3 parts) were charged into the vessel, followed by heating to 70° C. Benzyl acrylate (150 parts), acrylic acid (15 parts), butyl acrylate (5 parts), t-dodecyl mercaptan (1 part), methyl ethyl ketone (20 parts), and sodium persulfate (1 part) were separately provided and charged into the dropping funnel. The mixture was added dropwise to the reaction vessel over a period of 4 hours to perform polymerization reaction, thereby affording a dispersion polymer. Then methyl ethyl ketone was added to the reaction vessel to form a 40% dispersion polymer solution. After part of the polymer was dried, the glass transition temperature was measured with a differential scanning calorimeter (EXSTAR 6000DSC, manufactured by Seiko Instruments Inc.) and found to be 40° C.

The dispersion polymer solution (40 parts), Pigment Blue 15:3 (30 parts), a 0.1 mol/L sodium hydroxide aqueous solution (100 parts), and methyl ethyl ketone (30 parts) were mixed. The mixture was homogenized by 15 passes through an ultrahigh-pressure homogenizer (Ultimizer HJP-25005, manufactured by Sugino Machine Limited) at 200 MPa. The resulting mixture was transferred into another vessel. Ion-exchanged water (300 parts) was added thereto, followed by stirring for 1 hour. The total amount of methyl ethyl ketone and part of water were removed with a rotary evaporator. The mixture was neutralized with a 0.1 mol/L sodium hydroxide aqueous solution. The pH was adjusted to 9. The mixture was filtered through a 0.3-μm membrane filter. The filtered mixture was adjusted with ion-exchanged water to form pigment dispersoid B2 having a pigment concentration of 15%. The particle size was measured as in Example B1 and found to be 80 nm.

### Preparation of Polymeric Microparticles

Ion-exchanged water (100 parts) was charged into a reaction vessel equipped with a dropping device, a thermometer, a water-cooled reflux condenser, and a stirrer. Potassium persulfate (0.2 parts) serving as a polymerization initiator was added thereto under stirring at 70° C. in a nitrogen atmosphere. A monomer solution of sodium lauryl sulfate (0.05 parts), ethyl acrylate (19 parts), butyl acrylate (15 parts), tetrahydrofurfuryl acrylate (6 parts), butyl methacrylate (5 parts), and t-dodecyl mercaptan (0.02 parts) in ion-exchanged water (7 parts) was added dropwise thereto at 70° C. to perform reaction, preparing a primary material. A 10% ammonium persulfate solution (2 parts) was added to the primary material, followed by stirring. A reaction mixture of ion-exchanged water (30 parts), potassium lauryl sulfate (0.2 parts), ethyl acrylate (30 parts), methyl acrylate (25 parts), butyl acrylate (16 parts), acrylic acid (5 parts), and t-dodecyl mercaptan (0.5 parts) was added thereto at 70° C. under stirring to perform polymerization reaction. The mixture was neutralized with sodium hydroxide. The pH was adjusted to 8 to 8.5. The mixture was filtered through a 0.3-μm filter to prepare an aqueous polymeric microparticle dispersion. The resulting dispersion was referred to as emulsion BB (EM-BB). After part of the aqueous polymeric microparticle dispersion was dried, the glass transition temperature was measured with a differential scanning calorimeter (EXSTAR 6000DSC, manufactured by Seiko Instruments Inc.) and found to be −17° C. The molecular weight was measured as in Example B-1 and found to be 200,000. The acid value was measured by a titration method and found to be 20 mg KOH/g.

### (2) Preparation of Pigment Fixer

A pigment fixer was prepared by mixing an oxazoline-containing polymer (NK Linker FX, manufactured by Shin-Nakamura Chemical Co., Ltd.) with vehicle components shown in Table 10.

### (3) Method for Producing Printed Fabric

A printed fabric sample was produced as in Example B-1, except that the ink and the pigment fixer prepared in Example B-2 were used.

### (4) Abrasion Resistance Test and Dry-Cleaning Test

The sample (printed fabric) described above was subjected to an abrasion test and a dry-cleaning test as in Example B-1. Table 8 shows the results.

### (5) Measurement of Ejection Stability

The ejection stability was measured by the same method and evaluation method as in Example B-1, except that the ink prepared in Example B-2 was used. Table 8 shows the measurement results of the ejection stability.

### Example B-3

### (1) Preparation of Ink Jet Recording Ink

An ink jet recording ink was prepared by mixing vehicle components shown in Table 9 with pigment dispersoid B3 prepared by a method described below and emulsion BB prepared in Example B-2.

### Preparation of Pigment Dispersoid B3

Pigment dispersoid B3 was prepared in the same way as pigment dispersoid B2, except that Pigment Violet 19 (quinacridone pigment, manufactured by Clariant) was used. The particle size was measured as in Example B-1 and found to be 90 nm.

### (2) Preparation of Pigment Fixer

A pigment fixer was prepared by mixing an oxazoline-containing polymer (NK Linker FX, manufactured by Shin-Nakamura Chemical Co., Ltd.) with vehicle components shown in Table 10.

### (3) Method for Producing Printed Fabric

A printed fabric sample was produced as in Example B-1, except that the ink and the pigment fixer prepared in Example B-3 were used.

### (4) Abrasion Resistance Test and Dry-Cleaning Test

The sample (printed fabric) described above was subjected to an abrasion test and a dry-cleaning test as in Example B-1. Table 8 shows the results.

### (5) Measurement of Ejection Stability

The ejection stability was measured by the same method and evaluation method as in Example B-1, except that the ink prepared in Example B-3 was used. Table 8 shows the measurement results of the ejection stability.

### Example B-4

### (1) Preparation of Ink Jet Recording Ink

An ink jet recording ink was prepared by mixing vehicle components shown in Table 9 with pigment dispersoid B4 prepared by a method described below and emulsion BB prepared in Example B-2.

### Preparation of Pigment Dispersoid B4

Pigment dispersoid B4 was prepared in the same way as pigment dispersoid B2, except that Pigment Yellow 14 (azo-based pigment, manufactured by Clariant) was used. The particle size was measured as in Example B-1 and found to be 115 nm.

### (2) Preparation of Pigment Fixer

A pigment fixer was prepared by mixing an oxazoline-containing polymer (NK Linker FX, manufactured by Shin-Nakamura Chemical Co., Ltd.) with vehicle components shown in Table 10.

### (3) Method for Producing Printed Fabric

A printed fabric sample was produced as in Example B-1, except that the ink and the pigment fixer prepared in Example B-4 were used.

### (4) Abrasion Resistance Test and Dry-Cleaning Test

The sample (printed fabric) described above was subjected to an abrasion test and a dry-cleaning test as in Example B-1. Table 8 shows the results.

### (5) Measurement of Ejection Stability

The ejection stability was measured by the same method and evaluation method as in Example B-1, except that the ink prepared in Example B-4 was used. Table 8 shows the measurement results of the ejection stability.

### Comparative Example B-1

In Comparative Example B-1, an ink was prepared as in Example B-1, except that polymeric microparticles having a glass transition temperature of 0° C. were used, the polymeric microparticles being prepared in the same way as the ink in Example B-1, except that benzyl methacrylate (45 parts) was used in place of the total amount of ethyl acrylate (45 parts). An emulsion prepared using the polymeric microparticles was referred to as emulsion BC (EM-BC). Table 9 shows the ink composition. A pigment fixer was prepared by mixing an oxazoline-containing polymer (NK Linker FX, manufactured by Shin-Nakamura Chemical Co., Ltd.) with vehicle components shown in Table 10. The production of a printed fabric sample, an abrasion resistance test, a dry-cleaning test, and an ejection stability test were performed as in Example B-1.

Table 8 shows the results.

### Comparative Example B-2

In Comparative Example B-2, an ink was prepared as in Example B-2, except that polymeric microparticles having a glass transition temperature of 10° C. were used, the polymeric microparticles being prepared in the same way as the ink in Example B-2, except that benzyl methacrylate was used in place of the total amount of ethyl acrylate (49 parts) and that benzyl methacrylate (10 parts) was used in place of butyl acrylate (10 parts). An emulsion prepared using the polymeric microparticles was referred to as emulsion ED (EM-BD). Table 9 shows the ink composition. A pigment fixer was prepared by mixing an oxazoline-containing polymer (NK Linker FX, manufactured by Shin-Nakamura Chemical Co., Ltd.) with vehicle components shown in Table 10. The production of a printed fabric sample, an abrasion resistance test, a dry-cleaning test, and an ejection stability test were performed as in Example B-1. Table 8 shows the results.

### Reference Example B-3

In Reference Example B-3, inks were prepared as in Example B-3, except that a pigment dispersoid having a particle size of 350 nm and a pigment dispersoid having a particle size of 45 nm were prepared. The particle size was measured by the same method as in Example B-1. The dispersoid having a particle size of 350 nm was referred to as pigment dispersoid B3A. The dispersoid having a particle size of 45 nm was referred to as pigment dispersoid B3B. Table 9 shows the ink compositions. A pigment fixer was prepared by mixing an oxazoline-containing polymer (NK Linker FX, manufactured by Shin-Nakamura Chemical Co., Ltd.) with vehicle components shown in Table 10. The production of a printed fabric sample, an abrasion resistance test, a dry-cleaning test, and an ejection stability test were performed as in Example B-1. Table 8 shows the results.

### Comparative Example B-4

In Comparative Example B-4, inks were prepared as in Example B-4, except that polymeric microparticles having an acid value of 120 mg KOH/g and polymeric microparticles having an acid value of 150 mg KOH/g were prepared. An emulsion prepared using the polymeric microparticles having an acid value of 120 mg KOH/g was referred to as emulsion BE (EM-BE). An emulsion prepared using the polymeric microparticles having an acid value of 150 mg KOH/g was referred to as emulsion BF (EM-BF). Table 9 shows the ink compositions. A pigment fixer was prepared by mixing an oxazoline-containing polymer (NK Linker FX, manufactured by Shin-Nakamura Chemical Co., Ltd.) with vehicle components shown in Table 10. The production of a printed fabric sample, an abrasion resistance test, a dry-cleaning test, and an ejection stability test were performed as in Example B-1. Table 8 shows the results.

### Comparative Example B-5

In Comparative Example B-5, a pigment fixer was prepared as in Example B-2, except that the oxazoline-containing polymer (NK Linker FX, manufactured by Shin-Nakamura Chemical Co., Ltd.) was not used. Table 10 shows the composition of the pigment fixer. The same ink as in Example B-2 was used. Table 9 shows the ink composition. The production of a printed fabric sample, an abrasion resistance test, a dry-cleaning test, and an ejection stability test were performed as in Example B-1. Table 8 shows the results.

### Comparative Example B-6

In Comparative Example B-6, a pigment fixer was prepared as in Example B-3, except that the oxazoline-containing polymer (NK Linker FX, manufactured by Shin-Nakamura Chemical Co., Ltd.) was not used. Table 10 shows the composition of the pigment fixer. The same ink as in Example B-3 was used. Table 9 shows the ink composition. The production of a printed fabric sample, an abrasion resistance test, a dry-cleaning test, and an ejection stability test were performed as in Example B-1. Table 8 shows the results.

TABLE 8
Result of abrasion resistance, dry-cleaning resistance, and ejection stability in Examples
B-1 to 4, Comparative Examples B-1, 2, and 4 to 6, and Reference Example B-3

| | | Particle | Acid | Abrasion resistance | | Dry-cleaning | Ejection |
|---|---|---|---|---|---|---|---|
| | Tg | size | value | Dry | Wet | resistance | stability |
| Example B-1 | −15 | 110 | 20 | ¾ | ¾ | ⅘ | A |
| Example B-2 | −17 | 80 | 20 | 5 | ⅘ | 5 | A |
| Example B-3 | −17 | 90 | 20 | 5 | 5 | 5 | A |
| Example B-4 | −17 | 115 | 20 | 5 | 5 | 5 | A |
| Comparative Example B-1 | 0 | 110 | 20 | 3 | 2 | ⅔ | A |
| Comparative Example B-2 | 10 | 80 | 20 | ⅔ | ⅔ | 2 | A |
| Reference Example B-3 | −17 | 350 | 20 | 2 | 2 | ⅔ | D |
| | −17 | 45 | 20 | ¾ | ¾ | 4 | C |
| Comparative Example B-4 | −17 | 115 | 120 | 3 | 3 | 3 | A |
| | −17 | 115 | 150 | ⅔ | ⅔ | ¾ | B |
| Comparative Example B-5 | −17 | 80 | 20 | 2 | ½ | 5 | A |
| Comparative Example B-6 | −17 | 90 | 20 | 3 | ⅔ | 5 | A |

The unit of Tg is ° C.
The particle size indicates the average particle size of the pigment, and the unit thereof is nm.
The unit of the acid value is mg KOH/g.
The abrasion resistance and dry-cleaning resistance are evaluated according to JIS.

TABLE 9
Ink composition (mass %) in Examples B-1 to 4, Comparative Examples B-1, 2, and 4 to 6, and
Reference Example B-3

| | | | | | Comparative | | Reference | | | | | |
|---|---|---|---|---|---|---|---|---|---|---|---|---|
| | Example | | | | Example | | Example | | Comparative Example | | | |
| | B-1 | B-2 | B-3 | B-4 | B-1 | B-2 | B-3 | | B-4 | | B-5 | B-6 |
| Dispersoid B1 | 4.5 | — | — | — | 4.5 | — | — | — | — | — | — | — |
| Dispersoid B2 | — | 3.5 | — | — | — | 3.5 | — | — | — | — | 3.5 | — |
| Dispersoid B3 | — | — | 4.5 | — | — | — | — | — | — | — | — | 4.5 |
| Dispersoid B4 | — | — | — | 4.5 | — | — | — | — | 4.5 | 4.5 | — | — |
| Dispersoid | — | — | — | — | — | — | 4.5 | — | — | — | — | — |
| B3A | | | | | | | | | | | | |
| Dispersoid | — | — | — | — | — | — | — | 4.5 | — | — | — | — |
| B3B | | | | | | | | | | | | |
| EM-BA | 6.0 | — | — | — | — | — | — | — | — | — | — | — |
| EM-BB | — | 5.0 | 6.0 | 6.0 | — | — | 6.0 | 6.0 | — | — | 5.0 | 6.0 |
| EM-BC | — | — | — | — | 6.0 | — | — | — | — | — | — | — |
| EM-BD | — | — | — | — | — | 6.0 | — | — | — | — | — | — |
| EM-BE | — | — | — | — | — | — | — | — | 6.0 | — | — | — |
| EM-BF | — | — | — | — | — | — | — | — | — | 6.0 | — | — |
| 1,2-HD | 2.0 | 3.0 | 3.0 | 2.0 | 2.0 | 3.0 | 3.0 | 3.0 | 2.0 | 2.0 | 3.0 | 3.0 |
| 1,2-PD | — | — | — | 1.0 | — | — | — | — | 1.0 | 1.0 | — | — |
| TEGmBE | 2.0 | 1.0 | 1.0 | 2.0 | 2.0 | 1.0 | 1.0 | 1.0 | 2.0 | 2.0 | 1.0 | 1.0 |
| S-104 | 0.3 | 0.3 | 0.3 | 0.3 | 0.3 | 0.3 | 0.3 | 0.3 | 0.3 | 0.3 | 0.3 | 0.3 |
| S-465 | 0.5 | 0.5 | 0.3 | 0.5 | 0.5 | 0.5 | 0.3 | 0.3 | 0.5 | 0.5 | 0.5 | 0.3 |
| S-61 | — | — | 0.2 | — | — | — | 0.2 | 0.2 | — | — | — | 0.2 |
| Glycerol | 10.0 | 12.0 | 10.0 | 10.0 | 10.0 | 12.0 | 10.0 | 10.0 | 10.0 | 10.0 | 12.0 | 10.0 |
| TMP | 3.0 | 3.0 | 3.0 | 3.0 | 3.0 | 3.0 | 3.0 | 3.0 | 3.0 | 3.0 | 3.0 | 3.0 |
| TEG | 3.0 | 5.0 | 4.0 | 4.0 | 4.0 | 4.0 | 4.0 | 4.0 | 4.0 | 4.0 | 5.0 | 4.0 |
| 2-P | 1.0 | — | — | — | 1.0 | — | — | — | — | — | — | — |
| TEA | 1.0 | 1.0 | 1.0 | 1.0 | 1.0 | 1.0 | 1.0 | 1.0 | 1.0 | 1.0 | 1.0 | 1.0 |
| Ion exchanged | Balance | Balance | Balance | Balance | Balance | Balance | Balance | Balance | Balance | Balance | Balance | Balance |
| water | | | | | | | | | | | | |

The concentrations of pigments and polymers are expressed in terms of solid contents
1,2-HD 1,2-Hexanediol
1,2-PD 1,2-Pentanediol
TEGmBE Triethylene glycol monobutyl ether
S-104 Surfynol 104 (acetylenic glycol-based surfactant, manufactured by Nissin Chemical Industry Co., Ltd.)
S-465 Surfynol 465 (acetylenic glycol-based surfactant, manufactured by Nissin Chemical Industry Co., Ltd.)
S-61 Surfynol 61 (acetylenic alcohol-based surfactant, manufactured by Nissin Chemical Industry Co., Ltd.)
TMP Trimethylolpropane
TEG Triethylene glycol
2-P 2-Pyrrolidone
TEA Triethanolamine

TABLE 10
Composition (mass %) of pigment fixing solution in Examples B-1 to 4, Comparative Examples
B-1, 2, and 4 to 6, and Reference Example B-3

| | | | | | Comparative | | Reference | | | | | |
|---|---|---|---|---|---|---|---|---|---|---|---|---|
| | Example | | | | Example | | Example | | Comparative Example | | | |
| | B-1 | B-2 | B-3 | B-4 | B-1 | B-2 | B-3 | | B-4 | | B-5 | B-6 |
| NKLinkerFX | 2.0 | 3.0 | 3.0 | 2.0 | 2.0 | 3.0 | 3.0 | 3.0 | 2.0 | 2.0 | — | — |
| 1,2-HD | 2.0 | 3.0 | 3.0 | 2.0 | 2.0 | 3.0 | 3.0 | 3.0 | 2.0 | 2.0 | 3.0 | 3.0 |
| 1,2-PD | — | — | — | 1.0 | — | — | — | — | 1.0 | 1.0 | — | — |
| TEGmBE | 2.0 | 1.0 | 1.0 | 2.0 | 2.0 | 1.0 | 1.0 | 1.0 | 2.0 | 2.0 | 1.0 | 1.0 |
| S-104 | 0.3 | 0.3 | 0.3 | 0.3 | 0.3 | 0.3 | 0.3 | 0.3 | 0.3 | 0.3 | 0.3 | 0.3 |
| S-465 | 0.5 | 0.5 | 0.3 | 0.5 | 0.5 | 0.5 | 0.3 | 0.3 | 0.5 | 0.5 | 0.5 | 0.3 |
| S-61 | — | — | 0.2 | — | — | — | 0.2 | 0.2 | — | — | — | 0.2 |
| Glycerol | 10.0 | 12.0 | 10.0 | 10.0 | 10.0 | 12.0 | 10.0 | 10.0 | 10.0 | 10.0 | 12.0 | 10.0 |
| TMP | 3.0 | 3.0 | 3.0 | 3.0 | 3.0 | 3.0 | 3.0 | 3.0 | 3.0 | 3.0 | 3.0 | 3.0 |
| TEG | 3.0 | 5.0 | 4.0 | 4.0 | 4.0 | 4.0 | 4.0 | 4.0 | 4.0 | 4.0 | 5.0 | 4.0 |
| 2-P | 1.0 | — | — | — | 1.0 | — | — | — | — | — | — | — |
| TEA | 1.0 | 1.0 | 1.0 | 1.0 | 1.0 | 1.0 | 1.0 | 1.0 | 1.0 | 1.0 | 1.0 | 1.0 |
| Ion exchanged | Balance | Balance | Balance | Balance | Balance | Balance | Balance | Balance | Balance | Balance | Balance | Balance |
| water | | | | | | | | | | | | |

The polymer concentration is expressed in terms of a solid content.
NKLinkerFX Oxazoline-containing polymer emulsion manufactured by Shin-Nakamura Chemical Co., Ltd.
1,2-HD 1,2-Hexanediol
1,2-PD 1,2-Pentanediol
TEGmBE Triethylene glycol monobutyl ether
S-104 Surfynol 104 (acetylenic glycol-based surfactant, manufactured by Nissin Chemical Industry Co., Ltd.)
S-465 Surfynol 465 (acetylenic glycol-based surfactant, manufactured by Nissin Chemical Industry Co., Ltd.)
S-61 Surfynol 61 (acetylenic alcohol-based surfactant, manufactured by Nissin Chemical Industry Co., Ltd.)
TMP Trimethylolpropane
TEG Triethylene glycol
2-P 2-Pyrrolidone
TEA Triethanolamine

### Example B-5

### (1) Preparation of Ink Jet Recording Ink

An ink jet recording ink was prepared by mixing vehicle components shown in Table 12 with pigment dispersoid B5 and an aqueous polymeric microparticle dispersion (emulsion BI) prepared by methods described below.

### Preparation of Pigment Dispersoid B5

MA100 (manufactured by Mitsubishi Chemical Industries Ltd.) serving as carbon black (PBk7) was used for pigment dispersoid B5. Carbon black was subjected to surface oxidation so as to be dispersible in water by a method the same as in JP-A-8-3498, thereby affording dispersoid B5. The particle size was measured as in Example B-1 and found to be 120 nm.

### Preparation of Polymeric Microparticles

Ion-exchanged water (100 parts) was charged into a reaction vessel equipped with a dropping device, a thermometer, a water-cooled reflux condenser, and a stirrer. Potassium persulfate (0.3 parts) serving as a polymerization initiator was added thereto under stirring at 70° C. in a nitrogen atmosphere. A monomer solution of sodium lauryl sulfate (0.05 parts), ethyl acrylate (20 parts), butyl acrylate (15 parts), lauryl acrylate (6 parts), butyl methacrylate (5 parts), and t-dodecyl mercaptan (0.02 parts) in ion-exchanged water (7 parts) was added dropwise thereto at 70° C. to perform reaction, preparing a primary material. A 10% ammonium persulfate solution (2 parts) was added to the primary material, followed by stirring. A reaction mixture of ion-exchanged water (30 parts), potassium lauryl sulfate (0.2 parts), ethyl acrylate (30 parts), butyl acrylate (25 parts), lauryl acrylate (16 parts), acrylic acid (5 parts), and t-dodecyl mercaptan (0.5 parts) was added thereto at 70° C. under stirring to perform polymerization reaction. The mixture was neutralized with sodium hydroxide. The pH was adjusted to 8 to 8.5. The mixture was filtered through a 0.3-μm filter to prepare an aqueous polymeric microparticle dispersion. The resulting dispersion was referred to as emulsion BI (EM-BI). After part of the aqueous polymeric microparticle dispersion was dried, the glass transition temperature was measured with a differential scanning calorimeter (EXSTAR 6000DSC, manufactured by Seiko Instruments Inc.) and found to be −19° C. The molecular weight was measured as in Example B-1 and found to be 180,000. The acid value was measured by a titration method and found to be 18 mg KOH/g.

### (2) Preparation of Pigment Fixer

A pigment fixer was prepared by mixing an oxazoline-containing polymer (NK Linker FX, manufactured by Shin-Nakamura Chemical Co., Ltd.) with vehicle components shown in Table 13.

### (3) Method for Producing Printed Fabric

A printed fabric sample was produced as in Example B-1, except that the ink and the pigment fixer prepared in Example B-5 were used.

### (4) Abrasion Resistance Test and Dry-Cleaning Test

The sample (printed fabric) described above was subjected to an abrasion test and a dry-cleaning test as in Example B-1. Table 11 shows the results.

### (5) Measurement of Ejection Stability

The ejection stability was measured by the same method and evaluation method as in Example B-1, except that the ink prepared in Example B-5 was used. Table 11 shows the measurement results of the ejection stability.

### Example B-6

### (1) Preparation of Ink Jet Recording Ink

An ink jet recording ink was prepared by mixing vehicle components shown in Table 12 with pigment dispersoid B6 and an aqueous polymeric microparticle dispersion (emulsion BJ) prepared by methods described below.

### Preparation of Pigment Dispersoid B6

Pigment Blue 15:3 (copper phthalocyanine pigment, manufactured by Clariant) was used for pigment dispersoid B6. After an atmosphere in a reaction vessel equipped with a stirrer, a thermometer, a reflux condenser, and a dripping funnel was replaced with nitrogen, styrene (45 parts), polyethylene glycol 400 acrylate (30 parts), benzyl acrylate (10 parts), acrylic acid (2 parts), and t-dodecyl mercaptan (0.3 parts) were charged into the vessel, followed by heating to 70° C. Styrene (150 parts), polyethylene glycol 400 acrylate (100 parts), acrylic acid (15 parts), butyl acrylate (5 parts), t-dodecyl mercaptan (1 part), and sodium persulfate (5 parts) were separately provided and charged into the dropping funnel. The mixture was added dropwise to the reaction vessel over a period of 4 hours to perform polymerization reaction, thereby affording a dispersion polymer. Then water was added to the reaction vessel to form a 40% dispersion polymer solution. After part of the polymer was dried, the glass transition temperature was measured with a differential scanning calorimeter (EXSTAR 6000DSC, manufactured by Seiko Instruments Inc.) and found to be 45° C.

The dispersion polymer solution (40 parts), Pigment Blue 15:3 (copper phthalocyanine pigment, manufactured by Clariant) (30 parts), and a 0.1 mol/L sodium hydroxide aqueous solution (100 parts) were mixed. The mixture was subjected to dispersion with an Eiger mill using zirconia beads for 2 hours. The resulting mixture was transferred into another vessel. Ion-exchanged water (300 parts) was added thereto, followed by stirring for 1 hour. The mixture was neutralized with 0.1 mol/L sodium hydroxide. The pH was adjusted to 9. The mixture was filtered through a 0.3-μm membrane filter to form pigment dispersoid B6 having a solid content (the dispersion polymer and Pigment Blue 15:3) of 20%. The particle size was measured as in Example B-1 and found to be 100 nm. The molecular weight was measured and found to be 210,000.

### Preparation of Polymeric Microparticles

Ion-exchanged water (100 parts) was charged into a reaction vessel equipped with a dropping device, a thermometer, a water-cooled reflux condenser, and a stirrer. Potassium persulfate (0.3 parts) serving as a polymerization initiator was added thereto under stirring at 70° C. in a nitrogen atmosphere. A monomer solution of sodium lauryl sulfate (0.05 parts), ethyl acrylate (20 parts), butyl acrylate (25 parts), lauryl acrylate (6 parts), butyl methacrylate (5 parts), and t-dodecyl mercaptan (0.02 parts) in ion-exchanged water (7 parts) was dropwise thereto at 70° C. to perform reaction, preparing a primary material. A 10% ammonium persulfate solution (2 parts) was added to the primary material, followed by stirring. A reaction mixture of ion-exchanged water (30 parts), potassium lauryl sulfate (0.2 parts), ethyl acrylate (20 parts), butyl acrylate (20 parts), lauryl acrylate (20 parts), acrylic acid (5 parts), and t-dodecyl mercaptan (0.5 parts) was added thereto at 70° C. under stirring to perform polymerization reaction. The mixture was neutralized with sodium hydroxide. The pH was adjusted to 8 to 8.5. The mixture was filtered through a 0.3-μm filter to prepare an aqueous polymeric microparticle dispersion. The resulting dispersion was referred to as emulsion BJ (EM-BJ). After part of the aqueous polymeric microparticle dispersion was dried, the glass transition temperature was measured with a differential scanning calorimeter (EXSTAR 6000DSC, manufactured by Seiko Instruments Inc.) and found to be −21° C. The acid value was measured by a titration method and found to be 18 mg KOH/g.

### (2) Preparation of Pigment Fixer

A pigment fixer was prepared by mixing an oxazoline-containing polymer (NK Linker FX, manufactured by Shin-Nakamura Chemical Co., Ltd.) with vehicle components shown in Table 13.

### (3) Method for Producing Printed Fabric

A printed fabric sample was produced as in Example B-1, except that the ink and the pigment fixer prepared in Example B-6 were used.

### (4) Abrasion Resistance Test and Dry-Cleaning Test

The sample (printed fabric) described above was subjected to an abrasion test and a dry-cleaning test as in Example B-1. Table 11 shows the results.

### (5) Measurement of Ejection Stability

The ejection stability was measured by the same method and evaluation method as in Example B-1, except that the ink prepared in Example B-6 was used. Table 11 shows the measurement results of the ejection stability.

### Example B-7

### (1) Preparation of Ink Jet Recording Ink

An ink jet recording ink was prepared by mixing vehicle components shown in Table 12 with pigment dispersoid B7 prepared by a method described below and emulsion BJ prepared in Example B-6.

### Preparation of Pigment Dispersoid B7

Pigment dispersoid B7 was prepared in the same way as pigment dispersoid B6, except that Pigment Red 122 (dimethyl quinacridone pigment, manufactured by Clariant) was used. The particle size was measured as in Example B-1 and found to be 80 nm.

### (2) Preparation of Pigment Fixer

A pigment fixer was prepared by mixing an oxazoline-containing polymer (NK Linker FX, manufactured by Shin-Nakamura Chemical Co., Ltd.) with vehicle components shown in Table 13.

### (3) Method for Producing Printed Fabric

A printed fabric sample was produced as in Example B-1, except that the ink and the pigment fixer prepared in Example B-7 were used.

### (4) Abrasion Resistance Test and Dry-Cleaning Test

The sample (printed fabric) described above was subjected to an abrasion test and a dry-cleaning test as in Example B-1. Table 11 shows the results.

### (5) Measurement of Ejection Stability

The ejection stability was measured by the same method and evaluation method as in Example B-1, except that the ink prepared in Example B-7 was used. Table 11 shows the measurement results of the ejection stability.

### Example B-8

### (1) Preparation of Ink Jet Recording Ink

An ink jet recording ink was prepared by mixing vehicle components shown in Table 12 with pigment dispersoid B8 prepared by a method described below and emulsion BJ prepared in Example B-6.

### Preparation of Pigment Dispersoid B8

Pigment dispersoid B8 was prepared in the same way as pigment dispersoid B6, except that Pigment Yellow 180 (benzimidazolone-based disazo pigment, manufactured by Clariant) was used. The particle size was measured as in Example B-1 and found to be 130 nm.

### (2) Preparation of Pigment Fixer

A pigment fixer was prepared by mixing an oxazoline-containing polymer (NK Linker FX, manufactured by Shin-Nakamura Chemical Co., Ltd.) with vehicle components shown in Table 13.

### (3) Method for Producing Printed Fabric

A printed fabric sample was produced as in Example B-1, except that the ink and the pigment fixer prepared in Example B-8 were used.

### (4) Abrasion Resistance Test and Dry-Cleaning Test

The sample (printed fabric) described above was subjected to an abrasion test and a dry-cleaning test as in Example B-1. Table 11 shows the results.

### (5) Measurement of Ejection Stability

The ejection stability was measured by the same method and evaluation method as in Example B-1, except that the ink prepared in Example B-8 was used. Table 11 shows the measurement results of the ejection stability.

### Reference Example B-7

In Reference Example B-7, inks were prepared as in Example B-5, except that polymeric microparticles having a molecular weight of 90,000 and polymeric microparticles having a molecular weight of 1,100,000 were used. An emulsion having a molecular weight of 90,000 was referred to as emulsion BK (EM-BK). An emulsion having a molecular weight of 1,100,000 was referred to as emulsion BL (EM-BL). Table 12 shows the ink composition. A pigment fixer was prepared by mixing an oxazoline-containing polymer (NK Linker FX, manufactured by Shin-Nakamura Chemical Co., Ltd.) with vehicle components shown in Table 13. The production of a printed fabric sample, an abrasion resistance test, a dry-cleaning test, and an ejection stability test were performed as in Example B-1. Table 11 shows the results.

### Reference Example B-8

In Reference Example B-8, an ink was prepared as in Example B-6, except that glycerol was used in place of 1,2-hexanediol in the ink in Example B-6. Table 12 shows the ink composition. A pigment fixer was prepared by mixing an oxazoline-containing polymer (NK Linker FX, manufactured by Shin-Nakamura Chemical Co., Ltd.) with vehicle components shown in Table 13. The production of a printed fabric sample, an abrasion resistance test, a dry-cleaning test, and an ejection stability test were performed as in Example B-1. Table 11 shows the results.

### Reference Example B-9

In Reference Example B-9, an ink was prepared as in Example B-7, except that glycerol was used in place of the acetylenic glycol-based surfactant and the acetylenic alcohol-based surfactant in the ink in Example B-7. Table 12 shows the ink composition. A pigment fixer was prepared by mixing an oxazoline-containing polymer (NK Linker FX, manufactured by Shin-Nakamura Chemical Co., Ltd.) with vehicle components shown in Table 13. The production of a printed fabric sample, an abrasion resistance test, a dry-cleaning test, and an ejection stability test were performed as in Example B-1. Table 11 shows the results.

### Reference Example B-10

In Reference Example B-10, inks were prepared as in Example B-8, except that the proportions of the polymeric microparticles in the inks were set at 80% and 50% with respect to the pigment. Table 12 shows the ink composition. A pigment fixer was prepared by mixing an oxazoline-containing polymer (NK Linker FX, manufactured by Shin-Nakamura Chemical Co., Ltd.) with vehicle components shown in Table 13. The production of a printed fabric sample, an abrasion resistance test, a dry-cleaning test, and an ejection stability test were performed as in Example B-1. Table 11 shows the results.

### Reference Examples B-11 to 15

In Reference Examples B-11 to 15, solid patterns were printed on cotton fabrics by the method for producing a printed fabric in Example B-6 to form samples. The samples were subjected to heat treatment under various conditions different from the conditions in which heat treatment was performed at 150° C. for 5 minutes. The abrasion resistance was evaluated as in Example B-6. Reference Examples B-11 to in which different heat treatment conditions were used were compared with Example B-6. Table 14 shows the results.

TABLE 11
Result of abrasion resistance, dry-cleaning resistance, and ejection stability in Examples
B-5 to 8 and Reference Examples B-7 to 10

| | | | | | Proportion | Abrasion | | | |
|---|---|---|---|---|---|---|---|---|---|
| | | Particle | Acid | Molecular | with respect | resistance | | Dry-cleaning | Ejection |
| | Tg | size | value | weight | to pigment | Dry | Wet | resistance | stability |
| Example B-5 | −19 | 120 | 18 | 1.8 | 120 | 4 | 4 | 5 | A |
| Example B-6 | −21 | 100 | 18 | 2.0 | 150 | 5 | 5 | 5 | A |
| Example B-7 | −21 | 80 | 18 | 2.0 | 100 | 5 | 5 | 5 | A |
| Example B-8 | −21 | 130 | 18 | 2.0 | 120 | 5 | 5 | 5 | A |
| Reference | −19 | 120 | 18 | 0.9 | 120 | 3 | 3 | 2 | A |
| Example B-7 | −19 | 120 | 18 | 11.0 | 120 | 3 | ⅔ | 3 | D |
| Reference | −21 | 100 | 18 | 2.0 | 150 | 5 | ⅘ | 5 | C |
| Example B-8 | | | | | | | | | |
| Reference | −21 | 80 | 18 | 2.0 | 100 | ⅘ | ⅘ | 5 | C |
| Example B-9 | | | | | | | | | |
| Reference | −21 | 130 | 18 | 2.0 | 80 | ¾ | ¾ | 3 | A |
| Example B-10 | −21 | 130 | 18 | 2.0 | 50 | ⅔ | ⅔ | 2 | A |

The unit of Tg is ° C.
The particle size indicates the average particle size of the pigment, and the unit thereof is nm.
The unit of the acid value is mg KOH/g.
In Table 11, the molecular weight × 10⁵ is a molecular weight.
The proportion of the polymer to the pigment is indicated by percent.
The abrasion resistance and dry-cleaning resistance are evaluated according to JIS.

TABLE 12
Ink composition (mass %) in Examples B-5 to 8 and Reference Examples B-7 to 10

| | Example | | | | Reference Example | | | | | |
|---|---|---|---|---|---|---|---|---|---|---|
| | B-5 | B-6 | B-7 | B-8 | B-7 | | B-8 | B-9 | B-10 | |
| Dispersoid B5 | 4.0 | — | — | — | 4.0 | 4.0 | — | — | — | — |
| Dispersoid B6 | — | 3.2 | — | — | — | — | 3.2 | — | — | — |
| Dispersoid B7 | — | — | 4.0 | — | — | — | — | 4.0 | — | — |
| Dispersoid B8 | — | — | — | 4.0 | — | — | — | — | 4.0 | 4.0 |
| EM-BI | 5.0 | — | — | — | — | — | — | — | — | — |
| EM-BJ | — | 4.8 | 4.0 | 5.0 | — | — | 4.8 | 4.0 | 3.2 | 2 |
| EM-BK | — | — | — | — | 5.0 | — | — | — | — | — |
| EM-BL | — | — | — | — | — | 5.0 | — | — | — | — |
| 1,2-HD | 2.0 | 3.0 | 3.0 | 2.0 | 2.0 | 2.0 | — | 3.0 | 2.0 | 2.0 |
| 1,2-PD | — | — | — | 1.0 | — | — | — | — | 1.0 | 1.0 |
| TEGmBE | 2.0 | 1.0 | 1.0 | 2.0 | 2.0 | 2.0 | 1.0 | 1.0 | 2.0 | 2.0 |
| S-104 | 0.3 | 0.3 | 0.3 | 0.3 | 0.3 | 0.3 | 0.3 | — | 0.3 | 0.3 |
| S-465 | 0.5 | 0.5 | 0.3 | 0.5 | 0.5 | 0.5 | 0.3 | — | 0.5 | 0.5 |
| S-61 | — | — | 0.2 | — | — | — | 0.2 | — | — | — |
| Glycerol | 10.0 | 12.0 | 10.0 | 10.0 | 10.0 | 12.0 | 13.0 | 11.0 | 10.0 | 10.0 |
| TMP | 3.0 | 3.0 | 3.0 | 3.0 | 3.0 | 3.0 | 3.0 | 3.0 | 3.0 | 3.0 |
| TEG | 3.0 | 5.0 | 4.0 | 4.0 | 4.0 | 4.0 | 4.0 | 4.0 | 4.0 | 4.0 |
| 2-P | 1.0 | — | — | — | 1.0 | — | — | — | — | — |
| TEA | 1.0 | 1.0 | 1.0 | 1.0 | 1.0 | 1.0 | 1.0 | 1.0 | 1.0 | 1.0 |
| Ion exchanged water | Balance | Balance | Balance | Balance | Balance | Balance | Balance | Balance | Balance | Balance |

The concentrations of pigments and polymers are expressed in terms of solid contents
1,2-HD 1,2-Hexanediol
1,2-PD 1,2-Pentanediol
TEGmBE Triethylene glycol monobutyl ether
S-104 Surfynol 104 (acetylenic glycol-based surfactant, manufactured by Nissin Chemical Industry Co., Ltd.)
S-465 Surfynol 465 (acetylenic glycol-based surfactant, manufactured by Nissin Chemical Industry Co., Ltd.)
S-61 Surfynol 61 (acetylenic alcohol-based surfactant, manufactured by Nissin Chemical Industry Co., Ltd.)
TMP Trimethylolpropane
TEG Triethylene glycol
2-P 2-Pyrrolidone
TEA Triethanolamine

TABLE 13
Composition (mass %) of pigment fixing solution in Examples B-5 to 8 and Reference Examples
B-7 to 10

| | Example | | | | Reference Example | | | | | |
|---|---|---|---|---|---|---|---|---|---|---|
| | B-5 | B-6 | B-7 | B-8 | B-7 | | B-8 | B-9 | B-10 | |
| NKLinkerFX | 2.0 | 3.0 | 3.0 | 2.0 | 2.0 | 2.0 | 3.0 | 3.0 | 2.0 | 2.0 |
| 1,2-HD | 2.0 | 3.0 | 3.0 | 2.0 | 2.0 | 2.0 | — | 3.0 | 2.0 | 2.0 |
| 1,2-PD | — | — | — | 1.0 | — | — | — | — | 1.0 | 1.0 |
| TEGmBE | 2.0 | 1.0 | 1.0 | 2.0 | 2.0 | 2.0 | 1.0 | 1.0 | 2.0 | 2.0 |
| S-104 | 0.3 | 0.3 | 0.3 | 0.3 | 0.3 | 0.3 | 0.3 | — | 0.3 | 0.3 |
| S-465 | 0.5 | 0.5 | 0.3 | 0.5 | 0.5 | 0.5 | 0.3 | — | 0.5 | 0.5 |
| S-61 | — | — | 0.2 | — | — | — | 0.2 | — | — | — |
| Glycerol | 10.0 | 12.0 | 10.0 | 10.0 | 10.0 | 12.0 | 13.0 | 11.0 | 10.0 | 10.0 |
| TMP | 3.0 | 3.0 | 3.0 | 3.0 | 3.0 | 3.0 | 3.0 | 3.0 | 3.0 | 3.0 |
| TEG | 3.0 | 5.0 | 4.0 | 4.0 | 4.0 | 4.0 | 4.0 | 4.0 | 4.0 | 4.0 |
| 2-P | 1.0 | — | — | — | 1.0 | — | — | — | — | — |
| TEA | 1.0 | 1.0 | 1.0 | 1.0 | 1.0 | 1.0 | 1.0 | 1.0 | 1.0 | 1.0 |
| Ion exchanged water | Balance | Balance | Balance | Balance | Balance | Balance | Balance | Balance | Balance | Balance |

The polymer concentration is expressed in terms of a solid content.
NKLinkerFX Oxazoline-containing polymer emulsion manufactured by Shin-Nakamura Chemical Co., Ltd.
1,2-HD 1,2-Hexanediol
1,2-PD 1,2-Pentanediol
TEGmBE Triethylene glycol monobutyl ether
S-104 Surfynol 104 (acetylenic glycol-based surfactant, manufactured by Nissin Chemical Industry Co., Ltd.)
S-465 Surfynol 465 (acetylenic glycol-based surfactant, manufactured by Nissin Chemical Industry Co., Ltd.)
S-61 Surfynol 61 (acetylenic alcohol-based surfactant, manufactured by Nissin Chemical Industry Co., Ltd.)
TMP Trimethylolpropane
TEG Triethylene glycol
2-P 2-Pyrrolidone
TEA Triethanolamine

TABLE 14
Result of rubbing test in Example B-6 under various heating conditions

| | | | Abrasion | | |
|---|---|---|---|---|---|
| | Temperature | Time | resistance | | |
| | (° C.) | (min) | Dry | Wet | State |
| Example B-6 | 150 | 5 | 5 | 5 | Good |
| Reference Example B-11 | 100 | 5 | 3 | 3 | Good |
| Reference Example B-12 | 150 | 0.5 | 3 | 3 | Good |
| Reference Example B-13 | 210 | 5 | 4 | 4 | Cloth |
| | | | | | yellowed |
| Reference Example B-14 | 210 | 1 | 4 | 4 | Cloth |
| | | | | | yellowed |
| Reference Example B-15 | 100 | 20 | 3 | 3 | Good |

### Example C-1

### (1) Preparation of Ink Jet Recording Ink

An ink jet recording ink was prepared by mixing vehicle components shown in Table 9 with pigment dispersoid C1 and an aqueous polymeric microparticle dispersion (emulsion CA) prepared by methods described below. In each of this Example, other Examples, Comparative Examples, and Reference Examples of Example C series, ion-exchanged water (balance) in the ink contained 0.05% Topside 240 (manufactured by Permachem Asia, Ltd.) for preventing corrosion of the ink, 0.02% benzotriazole for preventing corrosion of ink jet head members, and 0.04% ethylenediaminetetraacetic acid disodium salt (EDTA•2Na) for reducing the effect of metal ions in the ink.

### Preparation of Pigment Dispersoid C1

Monarch 880 (manufactured by Cabot Corporation (USA)) serving as carbon black (Pigment Black 7) was used for Pigment dispersoid C1. Carbon black was subjected to surface oxidation so as to be dispersible in water by a method the same as in JP-A-8-3498, thereby affording dispersoid C1. The particle size was measured with Microtrac particle size distribution analyzer UPA250 (manufactured by Nikkiso Co., Ltd.) and found to be 110 nm.

### Preparation of Polymeric Microparticles

Ion-exchanged water (100 parts) was charged into a reaction vessel equipped with a dropping device, a thermometer, a water-cooled reflux condenser, and a stirrer. Potassium persulfate (0.2 parts) serving as a polymerization initiator was added thereto under stirring at 70° C. in a nitrogen atmosphere. A monomer solution of sodium lauryl sulfate (0.05 parts), glycidoxy acrylate (4 parts), ethyl acrylate (15 parts), butyl acrylate (15 parts), tetrahydrofurfuryl acrylate (6 parts), butyl methacrylate (5 parts), and t-dodecyl mercaptan (0.02 parts) in ion-exchanged water (7 parts) was added dropwise thereto at 70° C. to perform reaction, preparing a primary material. A 10% ammonium persulfate solution (2 parts) was added to the primary material, followed by stirring. A reaction mixture of ion-exchanged water (30 parts), potassium lauryl sulfate (0.2 parts), ethyl acrylate (30 parts), methyl acrylate (25 parts), butyl acrylate (6 parts), acrylic acid (5 parts), and t-dodecyl mercaptan (0.5 parts) was added thereto at 70° C. under stirring to perform polymerization reaction. The mixture was neutralized with sodium hydroxide. The pH was adjusted to 8 to 8.5. The mixture was filtered through a 0.3-μm filter to prepare an aqueous polymeric microparticle dispersion. The resulting dispersion was referred to as emulsion CA (EM-CA). After part of the aqueous polymeric microparticle dispersion was dried, the glass transition temperature was measured with a differential scanning calorimeter (EXSTAR 6000DSC, manufactured by Seiko Instruments Inc.) and found to be −15° C. The molecular weight in terms of styrene using THF as a solvent was measured by gel permeation chromatography (GPC) of L7100 System (manufactured by Hitachi, Ltd.) and found to be 150,000. The acid value was measured by a titration method and found to be 20 mg KOH/g.

### (2) Preparation of Pigment Fixer

A pigment fixer was prepared by mixing a polycarbodiimide (Carbodilite V-02, manufactured by Nisshinbo Industries, Inc.) with vehicle components shown in Table 10. Ion-exchanged water (balance) in each of the pigment fixers in this Example, other Examples, Comparative Examples, and Reference Examples of Example C series contained 0.05% Topside 240 (manufactured by Permachem Asia, Ltd.) for preventing corrosion of the ink, 0.02% benzotriazole for preventing corrosion of ink jet head members, and 0.04% ethylenediaminetetraacetic acid disodium salt (EDTA•2Na) for reducing the effect of metal ions in the ink.

### (3) Method for Producing Printed Fabric

A solid pattern was printed on a cotton fabric with the ink described above using an ink jet printer (PX-V600, manufactured by Seiko Epson Corporation) to form printed matter. Then a solid pattern was printed on the printed matter with the printer using the pigment fixer described above and subjected to heat treatment at 150° C. for 5 minutes to afford a printed fabric sample.

### (4) Abrasion Resistance Test and Dry-Cleaning Test

The sample (printed fabric) described above was subjected to an abrasion test with a Japan Society for the Promotion of Science-type color fastness rubbing tester (AB-301S, manufactured by Tester Sangyo Co., Ltd). In this test, the sample was rubbed 200 times under a load of 300 g. The degree of detachment of the ink was evaluated according to Japanese Industrial Standards (JIS) L0849 under two conditions: wet and dry. Similarly, a dry-cleaning test was performed according to Method B of JIS L0860. Table 15 shows the results of the abrasion resistance test and the dry-cleaning resistance test.

### (5) Measurement of Ejection Stability

Printing was performed on 100 pages of A4-size paper (Grade P, manufactured by Fuji Xerox Co., Ltd.) with the ink jet recording ink composition using an ink jet printer (PX-V600, manufactured by Seiko Epson Corporation) in an atmosphere maintained at 35° C. and 35% with Microsoft Word (manufactured by Microsoft Corporation) under the following conditions: font size: 11, format: standard, font type: MSP Gothic, and density: 4,000 characters per page, thereby evaluating the ejection stability. Evaluation criteria were as follows: AA: No print defect was observed, A: One print defect was observed, B: Two or three print defects were observed, C: Four or five print defects were observed, and D: Six or more print defects were observed. Table 15 shows the results.

### Example C-2

### (1) Preparation of Ink Jet Recording Ink

An ink jet recording ink was prepared by mixing vehicle components shown in Table 16 with pigment dispersoid C2 and an aqueous polymeric microparticle dispersion (emulsion CB) prepared by methods described below.

### Preparation of Pigment Dispersoid C2

Pigment Blue 15:3 (copper phthalocyanine pigment, manufactured by Clariant) was used for pigment dispersoid C2. After an atmosphere in a reaction vessel equipped with a stirrer, a thermometer, a reflux condenser, and a dripping funnel was replaced with nitrogen, benzyl acrylate (75 parts), acrylic acid (2 parts), and t-dodecyl mercaptan (0.3 parts) were charged into the vessel, followed by heating to 70° C. Benzyl acrylate (150 parts), acrylic acid (15 parts), butyl acrylate (5 parts), t-dodecyl mercaptan (1 part), methyl ethyl ketone (20 parts), and sodium persulfate (1 part) were separately provided and charged into the dropping funnel. The mixture was added dropwise to the reaction vessel over a period of 4 hours to perform polymerization reaction, thereby affording a dispersion polymer. Then methyl ethyl ketone was added to the reaction vessel to form a 40% dispersion polymer solution. After part of the polymer was dried, the glass transition temperature was measured with a differential scanning calorimeter (EXSTAR 6000DSC, manufactured by Seiko Instruments Inc.) and found to be 40° C.

The dispersion polymer solution (40 parts), Pigment Blue 15:3 (30 parts), a 0.1 mol/L sodium hydroxide aqueous solution (100 parts), and methyl ethyl ketone (30 parts) were mixed. The mixture was homogenized by 15 passes through an ultrahigh-pressure homogenizer (Ultimizer HJP-25005, manufactured by Sugino Machine Limited) at 200 MPa. The resulting mixture was transferred into another vessel. Ion-exchanged water (300 parts) was added thereto, followed by stirring for 1 hour. The total amount of methyl ethyl ketone and part of water were removed with a rotary evaporator. The mixture was neutralized with a 0.1 mol/L sodium hydroxide aqueous solution. The pH was adjusted to 9. The mixture was filtered through a 0.3-μm membrane filter. The filtered mixture was adjusted with ion-exchanged water to form pigment dispersoid C2 having a pigment concentration of 15%. The particle size was measured as in Example C-1 and found to be 80 nm.

### Preparation of Polymeric Microparticles

Ion-exchanged water (100 parts) was charged into a reaction vessel equipped with a dropping device, a thermometer, a water-cooled reflux condenser, and a stirrer. Potassium persulfate (0.2 parts) serving as a polymerization initiator was added thereto under stirring at 70° C. in a nitrogen atmosphere. A monomer solution of sodium lauryl sulfate (0.05 parts), ethyl acrylate (19 parts), butyl acrylate (15 parts), tetrahydrofurfuryl acrylate (6 parts), butyl methacrylate (5 parts), and t-dodecyl mercaptan (0.02 parts) in ion-exchanged water (7 parts) was added dropwise thereto at 70° C. to perform reaction, preparing a primary material. A 10% ammonium persulfate solution (2 parts) was added to the primary material, followed by stirring. A reaction mixture of ion-exchanged water (30 parts), potassium lauryl sulfate (0.2 parts), ethyl acrylate (30 parts), methyl acrylate (25 parts), butyl acrylate (16 parts), acrylic acid (5 parts), and t-dodecyl mercaptan (0.5 parts) was added thereto at 70° C. under stirring to perform polymerization reaction. The mixture was neutralized with sodium hydroxide. The pH was adjusted to 8 to 8.5. The mixture was filtered through a 0.3-μm filter to prepare an aqueous polymeric microparticle dispersion. The resulting dispersion was referred to as emulsion CB (EM-CB). After part of the aqueous polymeric microparticle dispersion was dried, the glass transition temperature was measured with a differential scanning calorimeter (EXSTAR 6000DSC, manufactured by Seiko Instruments Inc.) and found to be −17° C. The molecular weight was measured as in Example C-1 and found to be 200,000. The acid value was measured by a titration method and found to be 20 mg KOH/g.

### (2) Preparation of Pigment Fixer

A pigment fixer was prepared by mixing a polycarbodiimide (Carbodilite V-02, manufactured by Nisshinbo Industries, Inc.) with vehicle components shown in Table 17.

### (3) Method for Producing Printed Fabric

A printed fabric sample was produced as in Example C-1, except that the ink and the pigment fixer prepared in Example C-2 were used.

### (4) Abrasion Resistance Test and Dry-Cleaning Test

The sample (printed fabric) described above was subjected to an abrasion test and a dry-cleaning test as in Example C-1. Table 15 shows the results.

### (5) Measurement of Ejection Stability

The ejection stability was measured by the same method and evaluation method as in Example C-1, except that the ink prepared in Example C-2 was used. Table 15 shows the measurement results of the ejection stability.

### Example C-3

### (1) Preparation of Ink Jet Recording Ink

An ink jet recording ink was prepared by mixing vehicle components shown in Table 16 with pigment dispersoid C3 prepared by a method described below and emulsion CB prepared in Example C-2.

### Preparation of Pigment Dispersoid C3

Pigment dispersoid C3 was prepared in the same way as pigment dispersoid C2, except that Pigment Violet 19 (quinacridone pigment, manufactured by Clariant) was used. The particle size was measured as in Example C-1 and found to be 90 nm.

### (2) Preparation of Pigment Fixer

A pigment fixer was prepared by mixing a polycarbodiimide (Carbodilite V-02, manufactured by Nisshinbo Industries, Inc.) with vehicle components shown in Table 17.

### (3) Method for Producing Printed Fabric

A printed fabric sample was produced as in Example C-1, except that the ink and the pigment fixer prepared in Example C-3 were used.

### (4) Abrasion Resistance Test and Dry-Cleaning Test

The sample (printed fabric) described above was subjected to an abrasion test and a dry-cleaning test as in Example C-1. Table 15 shows the results.

### (5) Measurement of Ejection Stability

The ejection stability was measured by the same method and evaluation method as in Example C-1, except that the ink prepared in Example C-3 was used. Table 15 shows the measurement results of the ejection stability.

### Example C-4

### (1) Preparation of Ink Jet Recording Ink

An ink jet recording ink was prepared by mixing vehicle components shown in Table 16 with pigment dispersoid C4 prepared by a method described below and emulsion CB prepared in Example C-2.

### Preparation of Pigment Dispersoid C4

Pigment dispersoid C4 was prepared in the same way as pigment dispersoid C2, except that Pigment Yellow 14 (azo-based pigment, manufactured by Clariant) was used. The particle size was measured as in Example C-1 and found to be 115 nm.

### (2) Preparation of Pigment Fixer

A pigment fixer was prepared by mixing a polycarbodiimide (Carbodilite V-02, manufactured by Nisshinbo Industries, Inc.) with vehicle components shown in Table 17.

### (3) Method for Producing Printed Fabric

A printed fabric sample was produced as in Example C-1, except that the ink and the pigment fixer prepared in Example C-4 were used.

### (4) Abrasion Resistance Test and Dry-Cleaning Test

The sample (printed fabric) described above was subjected to an abrasion test and a dry-cleaning test as in Example C-1. Table 15 shows the results.

### (5) Measurement of Ejection Stability

The ejection stability was measured by the same method and evaluation method as in Example C-1, except that the ink prepared in Example C-4 was used. Table 15 shows the measurement results of the ejection stability.

### Comparative Example C-1)

In Comparative Example C-1, an ink was prepared as in Example C-1, except that polymeric microparticles having a glass transition temperature of 0° C. were used, the polymeric microparticles being prepared in the same way as the ink in Example C-1, except that benzyl methacrylate (45 parts) was used in place of the total amount of ethyl acrylate (45 parts). An emulsion prepared using the polymeric microparticles was referred to as emulsion CC (EM-CC). Table 16 shows the ink composition. A pigment fixer was prepared by mixing a polycarbodiimide (Carbodilite V-02, manufactured by Nisshinbo Industries, Inc.) with vehicle components shown in Table 17. The production of a printed fabric sample, an abrasion resistance test, a dry-cleaning test, and an ejection stability test were performed as in Example C-1.

### Comparative Example C-2

In Comparative Example C-2, an ink was prepared as in Example C-2, except that polymeric microparticles having a glass transition temperature of 10° C. were used, the polymeric microparticles being prepared in the same way as the ink in Example C-2, except that benzyl methacrylate was used in place of the total amount of ethyl acrylate (49 parts) and that benzyl methacrylate (10 parts) was used in place of butyl acrylate (10 parts). An emulsion prepared using the polymeric microparticles was referred to as emulsion CD (EM-CD). Table 16 shows the ink composition. A pigment fixer was prepared by mixing a polycarbodiimide (Carbodilite V-02, manufactured by Nisshinbo Industries, Inc.) with vehicle components shown in Table 17. The production of a printed fabric sample, an abrasion resistance test, a dry-cleaning test, and an ejection stability test were performed as in Example C-1. Table 15 shows the results.

### Reference Example C-3

In Reference Example C-3, inks were prepared as in Example C-3, except that a pigment dispersoid having a particle size of 350 nm and a pigment dispersoid having a particle size of 45 nm were prepared. The particle size was measured by the same method as in Example C-1. The dispersoid having a particle size of 350 nm was referred to as pigment dispersoid C3A. The dispersoid having a particle size of 45 nm was referred to as pigment dispersoid C3B. Table 16 shows the ink compositions. A pigment fixer was prepared by mixing a polycarbodiimide (Carbodilite V-02, manufactured by Nisshinbo Industries, Inc.) with vehicle components shown in Table 17. The production of a printed fabric sample, an abrasion resistance test, a dry-cleaning test, and an ejection stability test were performed as in Example C-1. Table 15 shows the results.

### Comparative Example C-4

In Comparative Example C-4, inks were prepared as in Example C-4, except that polymeric microparticles having an acid value of 120 mg KOH/g and polymeric microparticles having an acid value of 150 mg KOH/g were prepared. An emulsion prepared using the polymeric microparticles having an acid value of 120 mg KOH/g was referred to as emulsion CE (EM-CE). An emulsion prepared using the polymeric microparticles having an acid value of 150 mg KOH/g was referred to as emulsion CF (EM-CF). Table 16 shows the ink compositions. A pigment fixer was prepared by mixing a polycarbodiimide (Carbodilite V-02, manufactured by Nisshinbo Industries, Inc.) with vehicle components shown in Table 17. The production of a printed fabric sample, an abrasion resistance test, a dry-cleaning test, and an ejection stability test were performed as in Example C-1. Table 15 shows the results.

### Comparative Example C-5

In Comparative Example C-5, a pigment fixer was prepared as in Example C-2, except that the polycarbodiimide (Carbodilite V-02, manufactured by Nisshinbo Industries, Inc.) was not used. Table 17 shows the composition of the pigment fixer. The same ink as in Example C-2 was used. Table 16 shows the ink composition. The production of a printed fabric sample, an abrasion resistance test, a dry-cleaning test, and an ejection stability test were performed as in Example C-1. Table 15 shows the results.

### Comparative Example C-6

In Comparative Example C-6, a pigment fixer was prepared as in Example C-3, except that the polycarbodiimide (Carbodilite V-02, manufactured by Nisshinbo Industries, Inc.) was not used. Table 17 shows the composition of the pigment fixer. The same ink as in Example C-3 was used. Table 16 shows the ink composition. The production of a printed fabric sample, an abrasion resistance test, a dry-cleaning test, and an ejection stability test were performed as in Example C-1. Table 15 shows the results.

TABLE 15
Result of abrasion resistance, dry-cleaning resistance, and ejection stability in Examples
C-1 to 4, Comparative Examples C-1, 2, and 4 to 6, and Reference Example C-3

| | | | | Abrasion | | | |
|---|---|---|---|---|---|---|---|
| | | Particle | | resistance | | Dry-cleaning | Ejection |
| | Tg | size | Acid value | Dry | Wet | resistance | stability |
| Example C-1 | −15 | 110 | 20 | ¾ | ¾ | ⅘ | A |
| Example C-2 | −17 | 80 | 20 | 5 | ⅘ | 5 | A |
| Example C-3 | −17 | 90 | 20 | 5 | 5 | 5 | A |
| Example C-4 | −17 | 115 | 20 | 5 | 5 | 5 | A |
| Comparative Example C-1 | 0 | 110 | 20 | 3 | 2 | ⅔ | A |
| Comparative Example C-2 | 10 | 80 | 20 | ⅔ | ⅔ | 2 | A |
| Reference Example C-3 | −17 | 350 | 20 | 2 | 2 | ⅔ | D |
| | −17 | 45 | 20 | ¾ | ¾ | 4 | C |
| Comparative Example C-4 | −17 | 115 | 120 | 3 | 3 | 3 | A |
| | −17 | 115 | 150 | ⅔ | ⅔ | ¾ | B |
| Comparative Example C-5 | −17 | 80 | 20 | 2 | ½ | 5 | A |
| Comparative Example C-6 | −17 | 90 | 20 | 3 | ⅔ | 5 | A |

The unit of Tg is ° C.
The particle size indicates the average particle size of the pigment, and the unit thereof is nm.
The unit of the acid value is mg KOH/g.
The abrasion resistance and dry-cleaning resistance are evaluated according to JIS.

TABLE 16
Ink composition (mass %) in Examples C-1 to 4, Comparative Examples C-1, 2, and 4 to 6, and
Reference Example C-3

| | | | | | Comparative | | Reference | | | | | |
|---|---|---|---|---|---|---|---|---|---|---|---|---|
| | Example | | | | Example | | Example | | Comparative Example | | | |
| | C-1 | C-2 | C-3 | C-4 | C-1 | C-2 | C-3 | | C-4 | | C-5 | C-6 |
| Dispersoid C1 | 4.5 | — | — | — | 4.5 | — | — | — | — | — | — | — |
| Dispersoid C2 | — | 3.5 | — | — | — | 3.5 | — | — | — | — | 3.5 | — |
| Dispersoid C3 | — | — | 4.5 | — | — | — | — | — | — | — | — | 4.5 |
| Dispersoid C4 | — | — | — | 4.5 | — | — | — | — | 4.5 | 4.5 | — | — |
| Dispersoid | — | — | — | — | — | — | 4.5 | — | — | — | — | — |
| C3A | | | | | | | | | | | | |
| Dispersoid | — | — | — | — | — | — | — | 4.5 | — | — | — | — |
| C3B | | | | | | | | | | | | |
| EM-CA | 6.0 | — | — | — | — | — | — | — | — | — | — | — |
| EM-CB | — | 5.0 | 6.0 | 6.0 | — | — | 6.0 | 6.0 | — | — | 5.0 | 6.0 |
| EM-CC | — | — | — | — | 6.0 | — | — | — | — | — | — | — |
| EM-CD | — | — | — | — | — | 6.0 | — | — | — | — | — | — |
| EM-CE | — | — | — | — | — | — | — | — | 6.0 | — | — | — |
| EM-CF | — | — | — | — | — | — | — | — | — | 6.0 | — | — |
| 1,2-HD | 2.0 | 3.0 | 3.0 | 2.0 | 2.0 | 3.0 | 3.0 | 3.0 | 2.0 | 2.0 | 3.0 | 3.0 |
| 1,2-PD | — | — | — | 1.0 | — | — | — | — | 1.0 | 1.0 | — | — |
| TEGmBE | 2.0 | 1.0 | 1.0 | 2.0 | 2.0 | 1.0 | 1.0 | 1.0 | 2.0 | 2.0 | 1.0 | 1.0 |
| S-104 | 0.3 | 0.3 | 0.3 | 0.3 | 0.3 | 0.3 | 0.3 | 0.3 | 0.3 | 0.3 | 0.3 | 0.3 |
| S-465 | 0.5 | 0.5 | 0.3 | 0.5 | 0.5 | 0.5 | 0.3 | 0.3 | 0.5 | 0.5 | 0.5 | 0.3 |
| S-61 | — | — | 0.2 | — | — | — | 0.2 | 0.2 | — | — | — | 0.2 |
| Glycerol | 10.0 | 12.0 | 10.0 | 10.0 | 10.0 | 12.0 | 10.0 | 10.0 | 10.0 | 10.0 | 12.0 | 10.0 |
| TMP | 3.0 | 3.0 | 3.0 | 3.0 | 3.0 | 3.0 | 3.0 | 3.0 | 3.0 | 3.0 | 3.0 | 3.0 |
| TEG | 3.0 | 5.0 | 4.0 | 4.0 | 4.0 | 4.0 | 4.0 | 4.0 | 4.0 | 4.0 | 5.0 | 4.0 |
| 2-P | 1.0 | — | — | — | 1.0 | — | — | — | — | — | — | — |
| TEA | 1.0 | 1.0 | 1.0 | 1.0 | 1.0 | 1.0 | 1.0 | 1.0 | 1.0 | 1.0 | 1.0 | 1.0 |
| Ion exchanged | Balance | Balance | Balance | Balance | Balance | Balance | Balance | Balance | Balance | Balance | Balance | Balance |
| water | | | | | | | | | | | | |

The concentrations of pigments and polymers are expressed in terms of solid contents
1,2-HD 1,2-Hexanediol
1,2-PD 1,2-Pentanediol
TEGmBE Triethylene glycol monobutyl ether
S-104 Surfynol 104 (acetylenic glycol-based surfactant, manufactured by Nissin Chemical Industry Co., Ltd.)
S-465 Surfynol 465 (acetylenic glycol-based surfactant, manufactured by Nissin Chemical Industry Co., Ltd.)
S-61 Surfynol 61 (acetylenic alcohol-based surfactant, manufactured by Nissin Chemical Industry Co., Ltd.)
TMP Trimethylolpropane
TEG Triethylene glycol
2-P 2-Pyrrolidone
TEA Triethanolamine

TABLE 17
Composition (mass %) of pigment fixing solution in Examples C-1 to 4, Comparative Examples
C-1, 2, and 4 to 6, and Reference Example C-3

| | | | | | Comparative | | Reference | | | | | |
|---|---|---|---|---|---|---|---|---|---|---|---|---|
| | Example | | | | Example | | Example | | Comparative Example | | | |
| | C-1 | C-2 | C-3 | C-4 | C-1 | C-2 | C-3 | | C-4 | | C-5 | C-6 |
| V-02 | 2.0 | 3.0 | 3.0 | 2.0 | 2.0 | 3.0 | 3.0 | 3.0 | 2.0 | 2.0 | — | — |
| 1,2-HD | 2.0 | 3.0 | 3.0 | 2.0 | 2.0 | 3.0 | 3.0 | 3.0 | 2.0 | 2.0 | 3.0 | 3.0 |
| 1,2-PD | — | — | — | 1.0 | — | — | — | — | 1.0 | 1.0 | — | — |
| TEGmBE | 2.0 | 1.0 | 1.0 | 2.0 | 2.0 | 1.0 | 1.0 | 1.0 | 2.0 | 2.0 | 1.0 | 1.0 |
| S-104 | 0.3 | 0.3 | 0.3 | 0.3 | 0.3 | 0.3 | 0.3 | 0.3 | 0.3 | 0.3 | 0.3 | 0.3 |
| S-465 | 0.5 | 0.5 | 0.3 | 0.5 | 0.5 | 0.5 | 0.3 | 0.3 | 0.5 | 0.5 | 0.5 | 0.3 |
| S-61 | — | — | 0.2 | — | — | — | 0.2 | 0.2 | — | — | — | 0.2 |
| Glycerol | 10.0 | 12.0 | 10.0 | 10.0 | 10.0 | 12.0 | 10.0 | 10.0 | 10.0 | 10.0 | 12.0 | 10.0 |
| TMP | 3.0 | 3.0 | 3.0 | 3.0 | 3.0 | 3.0 | 3.0 | 3.0 | 3.0 | 3.0 | 3.0 | 3.0 |
| TEG | 3.0 | 5.0 | 4.0 | 4.0 | 4.0 | 4.0 | 4.0 | 4.0 | 4.0 | 4.0 | 5.0 | 4.0 |
| 2-P | 1.0 | — | — | — | 1.0 | — | — | — | — | — | — | — |
| TEA | 1.0 | 1.0 | 1.0 | 1.0 | 1.0 | 1.0 | 1.0 | 1.0 | 1.0 | 1.0 | 1.0 | 1.0 |
| Ion exchanged | Balance | Balance | Balance | Balance | Balance | Balance | Balance | Balance | Balance | Balance | Balance | Balance |
| water | | | | | | | | | | | | |

The polymer concentration is expressed in terms of a solid content.
V-02 Polycarbodiimide (Carbodilite V-02, manufactured by Nisshinbo Industries, Inc.)
1,2-HD 1,2-Hexanediol
1,2-PD 1,2-Pentanediol
TEGmBE Triethylene glycol monobutyl ether
S-104 Surfynol 104 (acetylenic glycol-based surfactant, manufactured by Nissin Chemical Industry Co., Ltd.)
S-465 Surfynol 465 (acetylenic glycol-based surfactant, manufactured by Nissin Chemical Industry Co., Ltd.)
S-61 Surfynol 61 (acetylenic alcohol-based surfactant, manufactured by Nissin Chemical Industry Co., Ltd.)
TMP Trimethylolpropane
TEG Triethylene glycol
2-P 2-Pyrrolidone
TEA Triethanolamine

### Example C-5

### (1) Preparation of Ink Jet Recording Ink

An ink jet recording ink was prepared by mixing vehicle components shown in Table 19 with pigment dispersoid C5 and an aqueous polymeric microparticle dispersion (emulsion CI) prepared by methods described below.

### Preparation of Pigment Dispersoid C5

MA100 (manufactured by Mitsubishi Chemical Industries Ltd.) serving as carbon black (PBk7) was used for pigment dispersoid C5. Carbon black was subjected to surface oxidation so as to be dispersible in water by a method the same as in JP-A-8-3498, thereby affording dispersoid C5. The particle size was measured as in Example C-1 and found to be 120 nm.

### Preparation of Polymeric Microparticles

Ion-exchanged water (100 parts) was charged into a reaction vessel equipped with a dropping device, a thermometer, a water-cooled reflux condenser, and a stirrer. Potassium persulfate (0.3 parts) serving as a polymerization initiator was added thereto under stirring at 70° C. in a nitrogen atmosphere. A monomer solution of sodium lauryl sulfate (0.05 parts), ethyl acrylate (20 parts), butyl acrylate (15 parts), lauryl acrylate (6 parts), butyl methacrylate (5 parts), and t-dodecyl mercaptan (0.02 parts) in ion-exchanged water (7 parts) was added dropwise thereto at 70° C. to perform reaction, preparing a primary material. A 10% ammonium persulfate solution (2 parts) was added to the primary material, followed by stirring. A reaction mixture of ion-exchanged water (30 parts), potassium lauryl sulfate (0.2 parts), ethyl acrylate (30 parts), butyl acrylate (25 parts), lauryl acrylate (16 parts), acrylic acid (5 parts), and t-dodecyl mercaptan (0.5 parts) was added thereto at 70° C. under stirring to perform polymerization reaction. The mixture was neutralized with sodium hydroxide. The pH was adjusted to 8 to 8.5. The mixture was filtered through a 0.3-μm filter to prepare an aqueous polymeric microparticle dispersion. The resulting dispersion was referred to as emulsion CI (EM-CI). After part of the aqueous polymeric microparticle dispersion was dried, the glass transition temperature was measured with a differential scanning calorimeter (EXSTAR 6000DSC, manufactured by Seiko Instruments Inc.) and found to be −19° C. The molecular weight was measured as in Example C-1 and found to be 180,000. The acid value was measured by a titration method and found to be 18 mg KOH/g.

### (2) Preparation of Pigment Fixer

A pigment fixer was prepared by mixing a polycarbodiimide (Carbodilite V-02, manufactured by Nisshinbo Industries, Inc.) with vehicle components shown in Table 20.

### (3) Method for Producing Printed Fabric

A printed fabric sample was produced as in Example C-1, except that the ink and the pigment fixer prepared in Example C-5 were used.

### (4) Abrasion Resistance Test and Dry-Cleaning Test

The sample (printed fabric) described above was subjected to an abrasion test and a dry-cleaning test as in Example C-1. Table 18 shows the results.

### (5) Measurement of Ejection Stability

The ejection stability was measured by the same method and evaluation method as in Example C-1, except that the ink prepared in Example C-5 was used. Table 18 shows the measurement results of the ejection stability.

### Example C-6

### (1) Preparation of Ink Jet Recording Ink

An ink jet recording ink was prepared by mixing vehicle components shown in Table 19 with pigment dispersoid C6 and an aqueous polymeric microparticle dispersion (emulsion CJ) prepared by methods described below.

### Preparation of Pigment Dispersoid C6

Pigment Blue 15:3 (copper phthalocyanine pigment, manufactured by Clariant) was used for pigment dispersoid C6. After an atmosphere in a reaction vessel equipped with a stirrer, a thermometer, a reflux condenser, and a dripping funnel was replaced with nitrogen, styrene (45 parts), polyethylene glycol 400 acrylate (30 parts), benzyl acrylate (10 parts), acrylic acid (2 parts), and t-dodecyl mercaptan (0.3 parts) were charged into the vessel, followed by heating to 70° C. Styrene (150 parts), polyethylene glycol 400 acrylate (100 parts), acrylic acid (15 parts), butyl acrylate (5 parts), t-dodecyl mercaptan (1 part), and sodium persulfate (5 parts) were separately provided and charged into the dropping funnel. The mixture was added dropwise to the reaction vessel over a period of 4 hours to perform polymerization reaction, thereby affording a dispersion polymer. Then water was added to the reaction vessel to form a 40% dispersion polymer solution. After part of the polymer was dried, the glass transition temperature was measured with a differential scanning calorimeter (EXSTAR 6000DSC, manufactured by Seiko Instruments Inc.) and found to be 45° C.

The dispersion polymer solution (40 parts), Pigment Blue 15:3 (copper phthalocyanine pigment, manufactured by Clariant) (30 parts), and a 0.1 mol/L sodium hydroxide aqueous solution (100 parts) were mixed. The mixture was subjected to dispersion with an Eiger mill using zirconia beads for 2 hours. The resulting mixture was transferred into another vessel. Ion-exchanged water (300 parts) was added thereto, followed by stirring for 1 hour. The mixture was neutralized with 0.1 mol/L sodium hydroxide. The pH was adjusted to 9. The mixture was filtered through a 0.3-μm membrane filter to form pigment dispersoid C6 having a solid content (the dispersion polymer and Pigment Blue 15:3) of 20%. The particle size was measured as in Example C-1 and found to be 100 nm. The molecular weight was measured and found to be 210,000.

### Preparation of Polymeric Microparticles

Ion-exchanged water (100 parts) was charged into a reaction vessel equipped with a dropping device, a thermometer, a water-cooled reflux condenser, and a stirrer. Potassium persulfate (0.3 parts) serving as a polymerization initiator was added thereto under stirring at 70° C. in a nitrogen atmosphere. A monomer solution of sodium lauryl sulfate (0.05 parts), ethyl acrylate (20 parts), butyl acrylate (25 parts), lauryl acrylate (6 parts), butyl methacrylate (5 parts), and t-dodecyl mercaptan (0.02 parts) in ion-exchanged water (7 parts) was dropwise thereto at 70° C. to perform reaction, preparing a primary material. A 10% ammonium persulfate solution (2 parts) was added to the primary material, followed by stirring. A reaction mixture of ion-exchanged water (30 parts), potassium lauryl sulfate (0.2 parts), ethyl acrylate (20 parts), butyl acrylate (20 parts), lauryl acrylate (20 parts), acrylic acid (5 parts), and t-dodecyl mercaptan (0.5 parts) was added thereto at 70° C. under stirring to perform polymerization reaction. The mixture was neutralized with sodium hydroxide. The pH was adjusted to 8 to 8.5. The mixture was filtered through a 0.3-μm filter to prepare an aqueous polymeric microparticle dispersion. The resulting dispersion was referred to as emulsion CJ (EM-CJ). After part of the aqueous polymeric microparticle dispersion was dried, the glass transition temperature was measured with a differential scanning calorimeter (EXSTAR 6000DSC, manufactured by Seiko Instruments Inc.) and found to be −21° C. The acid value was measured by a titration method and found to be 18 mg KOH/g.

### (2) Preparation of Pigment Fixer

A pigment fixer was prepared by mixing a polycarbodiimide (Carbodilite V-02, manufactured by Nisshinbo Industries, Inc.) with vehicle components shown in Table 20.

### (3) Method for Producing Printed Fabric

A printed fabric sample was produced as in Example C-1, except that the ink and the pigment fixer prepared in Example C-6 were used.

### (4) Abrasion Resistance Test and Dry-Cleaning Test

The sample (printed fabric) described above was subjected to an abrasion test and a dry-cleaning test as in Example C-1. Table 18 shows the results.

### (5) Measurement of Ejection Stability

The ejection stability was measured by the same method and evaluation method as in Example C-1, except that the ink prepared in Example C-6 was used. Table 18 shows the measurement results of the ejection stability.

### Example C-7

### (1) Preparation of Ink Jet Recording Ink

An ink jet recording ink was prepared by mixing vehicle components shown in Table 19 with pigment dispersoid C7 prepared by a method described below and emulsion CJ prepared in Example C-6.

### Preparation of Pigment Dispersoid C7

Pigment dispersoid C7 was prepared in the same way as pigment dispersoid C6, except that Pigment Red 122 (dimethyl quinacridone pigment, manufactured by Clariant) was used. The particle size was measured as in Example C-1 and found to be 80 nm.

### (2) Preparation of Pigment Fixer

A pigment fixer was prepared by mixing a polycarbodiimide (Carbodilite V-02, manufactured by Nisshinbo Industries, Inc.) with vehicle components shown in Table 20.

### (3) Method for Producing Printed Fabric

A printed fabric sample was produced as in Example C-1, except that the ink and the pigment fixer prepared in Example C-7 were used.

### (4) Abrasion Resistance Test and Dry-Cleaning Test

The sample (printed fabric) described above was subjected to an abrasion test and a dry-cleaning test as in Example C-1. Table 18 shows the results.

### (5) Measurement of Ejection Stability

The ejection stability was measured by the same method and evaluation method as in Example C-1, except that the ink prepared in Example C-7 was used. Table 18 shows the measurement results of the ejection stability.

### Example C-8

### (1) Preparation of Ink Jet Recording Ink

An ink jet recording ink was prepared by mixing vehicle components shown in Table 19 with pigment dispersoid C8 prepared by a method described below and emulsion CJ prepared in Example C-6.

### Preparation of Pigment Dispersoid C8

Pigment dispersoid C8 was prepared in the same way as pigment dispersoid C6, except that Pigment Yellow 180 (benzimidazolone-based disazo pigment, manufactured by Clariant) was used. The particle size was measured as in Example C-1 and found to be 130 nm.

### (2) Preparation of Pigment Fixer

A pigment fixer was prepared by mixing a polycarbodiimide (Carbodilite V-02, manufactured by Nisshinbo Industries, Inc.) with vehicle components shown in Table 20.

### (3) Method for Producing Printed Fabric

A printed fabric sample was produced as in Example C-1, except that the ink and the pigment fixer prepared in Example C-8 were used.

### (4) Abrasion Resistance Test and Dry-Cleaning Test

The sample (printed fabric) described above was subjected to an abrasion test and a dry-cleaning test as in Example C-1. Table 18 shows the results.

### (5) Measurement of Ejection Stability

The ejection stability was measured by the same method and evaluation method as in Example C-1, except that the ink prepared in Example C-8 was used. Table 18 shows the measurement results of the ejection stability.

### Reference Example C-7

In Reference Example C-7, inks were prepared as in Example C-5, except that polymeric microparticles having a molecular weight of 90,000 and polymeric microparticles having a molecular weight of 1,100,000 were used. An emulsion having a molecular weight of 90,000 was referred to as emulsion CK (EM-CK). An emulsion having a molecular weight of 1,100,000 was referred to as emulsion CL (EM-CL). Table 19 shows the ink composition. A pigment fixer was prepared by mixing a polycarbodiimide (Carbodilite V-02, manufactured by Nisshinbo Industries, Inc.) with vehicle components shown in Table 20. The production of a printed fabric sample, an abrasion resistance test, a dry-cleaning test, and an ejection stability test were performed as in Example C-1. Table 18 shows the results.

### Reference Example C-8

In Reference Example C-8, an ink was prepared as in Example C-6, except that glycerol was used in place of 1,2-hexanediol in the ink in Example C-6. Table 19 shows the ink composition. A pigment fixer was prepared by mixing a polycarbodiimide (Carbodilite V-02, manufactured by Nisshinbo Industries, Inc.) with vehicle components shown in Table 20. The production of a printed fabric sample, an abrasion resistance test, a dry-cleaning test, and an ejection stability test were performed as in Example C-1. Table 18 shows the results.

### Reference Example C-9

In Reference Example C-9, an ink was prepared as in Example C-7, except that glycerol was used in place of the acetylenic glycol-based surfactant and the acetylenic alcohol-based surfactant in the ink in Example C-7. Table 19 shows the ink composition. A pigment fixer was prepared by mixing a polycarbodiimide (Carbodilite V-02, manufactured by Nisshinbo Industries, Inc.) with vehicle components shown in Table 20. The production of a printed fabric sample, an abrasion resistance test, a dry-cleaning test, and an ejection stability test were performed as in Example c-1. Table 18 shows the results.

### Reference Example C-10

In Reference Example C-10, inks were prepared as in Example C-8, except that the proportions of the polymeric microparticles in the inks were set at 80% and 50% with respect to the pigment. Table 19 shows the ink composition. A pigment fixer was prepared by mixing a polycarbodiimide (Carbodilite V-02, manufactured by Nisshinbo Industries, Inc.) with vehicle components shown in Table 20. The production of a printed fabric sample, an abrasion resistance test, a dry-cleaning test, and an ejection stability test were performed as in Example C-1. Table 18 shows the results.

### Reference Examples C-11 to 15

In Reference Examples C-11 to 15, solid patterns were printed on cotton fabrics by the method for producing a printed fabric in Example C-6 to form samples. The samples were subjected to heat treatment under various conditions different from the conditions in which heat treatment was performed at 150° C. for 5 minutes. The abrasion resistance was evaluated as in Example C-6. Reference Examples C-11 to in which different heat treatment conditions were used were compared with Example C-6. Table 21 shows the results.

TABLE 18
Result of abrasion resistance, dry-cleaning resistance, and ejection stability in Examples
C-5 to 8 and Reference Examples C-7 to 10

| | | | | | Proportion | Abrasion | | | |
|---|---|---|---|---|---|---|---|---|---|
| | | Particle | Acid | Molecular | with respect | resistance | | Dry-cleaning | Ejection |
| | Tg | size | value | weight | to pigment | Dry | Wet | resistance | stability |
| Example C-5 | −19 | 120 | 18 | 1.8 | 120 | 4 | 4 | 5 | A |
| Example C-6 | −21 | 100 | 18 | 2.0 | 150 | 5 | 5 | 5 | A |
| Example C-7 | −21 | 80 | 18 | 2.0 | 100 | 5 | 5 | 5 | A |
| Example C-8 | −21 | 130 | 18 | 2.0 | 120 | 5 | 5 | 5 | A |
| Reference Example C-7 | −19 | 120 | 18 | 0.9 | 120 | 3 | 3 | 2 | A |
| | −19 | 120 | 18 | 11.0 | 120 | 3 | ⅔ | 3 | D |
| Reference Example C-8 | −21 | 100 | 18 | 2.0 | 150 | 5 | ⅘ | 5 | C |
| Reference Example C-9 | −21 | 80 | 18 | 2.0 | 100 | ⅘ | ⅘ | 5 | C |
| Reference Example C-10 | −21 | 130 | 18 | 2.0 | 80 | ¾ | ¾ | 3 | A |
| | −21 | 130 | 18 | 2.0 | 50 | ⅔ | ⅔ | 2 | A |

The unit of Tg is ° C.
The particle size indicates the average particle size of the pigment, and the unit thereof is nm. The unit of the acid value is mg KOH/g.
In Table 18, the molecular weight × 10⁵ is a molecular weight.
The proportion of the polymer to the pigment is indicated by percent.
The abrasion resistance and dry-cleaning resistance are evaluated according to JIS.

TABLE 19
Ink composition (mass %) in Examples C-5 to 8 and Reference Examples C-7 to 10

| | Example | | | | Reference Example | | | | | |
|---|---|---|---|---|---|---|---|---|---|---|
| | C-5 | C-6 | C-7 | C-8 | C-7 | | C-8 | C-9 | C-10 | |
| Dispersoid C5 | 4.0 | — | — | — | 4.0 | 4.0 | — | — | — | — |
| Dispersoid C6 | — | 3.2 | — | — | — | — | 3.2 | — | — | — |
| Dispersoid C7 | — | — | 4.0 | — | — | — | — | 4.0 | — | — |
| Dispersoid C8 | — | — | — | 4.0 | — | — | — | — | 4.0 | 4.0 |
| EM-CI | 5.0 | — | — | — | — | — | — | — | — | — |
| EM-CJ | — | 4.8 | 4.0 | 5.0 | — | — | 4.8 | 4.0 | 3.2 | 2 |
| EM-CK | — | — | — | — | 5.0 | — | — | — | — | — |
| EM-CL | — | — | — | — | — | 5.0 | — | — | — | — |
| 1,2-HD | 2.0 | 3.0 | 3.0 | 2.0 | 2.0 | 2.0 | — | 3.0 | 2.0 | 2.0 |
| 1,2-PD | — | — | — | 1.0 | — | — | — | — | 1.0 | 1.0 |
| TEGmBE | 2.0 | 1.0 | 1.0 | 2.0 | 2.0 | 2.0 | 1.0 | 1.0 | 2.0 | 2.0 |
| S-104 | 0.3 | 0.3 | 0.3 | 0.3 | 0.3 | 0.3 | 0.3 | — | 0.3 | 0.3 |
| S-465 | 0.5 | 0.5 | 0.3 | 0.5 | 0.5 | 0.5 | 0.3 | — | 0.5 | 0.5 |
| S-61 | — | — | 0.2 | — | — | — | 0.2 | — | — | — |
| Glycerol | 10.0 | 12.0 | 10.0 | 10.0 | 10.0 | 12.0 | 13.0 | 11.0 | 10.0 | 10.0 |
| TMP | 3.0 | 3.0 | 3.0 | 3.0 | 3.0 | 3.0 | 3.0 | 3.0 | 3.0 | 3.0 |
| TEG | 3.0 | 5.0 | 4.0 | 4.0 | 4.0 | 4.0 | 4.0 | 4.0 | 4.0 | 4.0 |
| 2-P | 1.0 | — | — | — | 1.0 | — | — | — | — | — |
| TEA | 1.0 | 1.0 | 1.0 | 1.0 | 1.0 | 1.0 | 1.0 | 1.0 | 1.0 | 1.0 |
| Ion exchanged water | Balance | Balance | Balance | Balance | Balance | Balance | Balance | Balance | Balance | Balance |

The concentrations of pigments and polymers are expressed in terms of solid contents
1,2-HD 1,2-Hexanediol
1,2-PD 1,2-Pentanediol
TEGmBE Triethylene glycol monobutyl ether
S-104 Surfynol 104 (acetylenic glycol-based surfactant, manufactured by Nissin Chemical Industry Co., Ltd.)
S-465 Surfynol 465 (acetylenic glycol-based surfactant, manufactured by Nissin Chemical Industry Co., Ltd.)
S-61 Surfynol 61 (acetylenic alcohol-based surfactant, manufactured by Nissin Chemical Industry Co., Ltd.)
TMP Trimethylolpropane
TEG Triethylene glycol
2-P 2-Pyrrolidone
TEA Triethanolamine

TABLE 20
Composition (mass %) of pigment fixing solution in Examples C-5 to 8 and Reference Examples
C-7 to 10

| | Example | | | | Reference Example | | | | | |
|---|---|---|---|---|---|---|---|---|---|---|
| | C-5 | C-6 | C-7 | C-8 | C-7 | | C-8 | C-9 | C-10 | |
| V-02 | 2.0 | 3.0 | 3.0 | 2.0 | 2.0 | 2.0 | 3.0 | 3.0 | 2.0 | 2.0 |
| 1,2-HD | 2.0 | 3.0 | 3.0 | 2.0 | 2.0 | 2.0 | — | 3.0 | 2.0 | 2.0 |
| 1,2-PD | — | — | — | 1.0 | — | — | — | — | 1.0 | 1.0 |
| TEGmBE | 2.0 | 1.0 | 1.0 | 2.0 | 2.0 | 2.0 | 1.0 | 1.0 | 2.0 | 2.0 |
| S-104 | 0.3 | 0.3 | 0.3 | 0.3 | 0.3 | 0.3 | 0.3 | — | 0.3 | 0.3 |
| S-465 | 0.5 | 0.5 | 0.3 | 0.5 | 0.5 | 0.5 | 0.3 | — | 0.5 | 0.5 |
| S-61 | — | — | 0.2 | — | — | — | 0.2 | — | — | — |
| Glycerol | 10.0 | 12.0 | 10.0 | 10.0 | 10.0 | 12.0 | 13.0 | 11.0 | 10.0 | 10.0 |
| TMP | 3.0 | 3.0 | 3.0 | 3.0 | 3.0 | 3.0 | 3.0 | 3.0 | 3.0 | 3.0 |
| TEG | 3.0 | 5.0 | 4.0 | 4.0 | 4.0 | 4.0 | 4.0 | 4.0 | 4.0 | 4.0 |
| 2-P | 1.0 | — | — | — | 1.0 | — | — | — | — | — |
| TEA | 1.0 | 1.0 | 1.0 | 1.0 | 1.0 | 1.0 | 1.0 | 1.0 | 1.0 | 1.0 |
| Ion exchanged water | Balance | Balance | Balance | Balance | Balance | Balance | Balance | Balance | Balance | Balance |

The polymer concentration is expressed in terms of a solid content.
V-02 Polycarbodiimide (Carbodilite V-02, manufactured by Nisshinbo Industries, Inc.)
1,2-HD 1,2-Hexanediol
1,2-PD 1,2-Pentanediol
TEGmBE Triethylene glycol monobutyl ether
S-104 Surfynol 104 (acetylenic glycol-based surfactant, manufactured by Nissin Chemical Industry Co., Ltd.)
S-465 Surfynol 465 (acetylenic glycol-based surfactant, manufactured by Nissin Chemical Industry Co., Ltd.)
S-61 Surfynol 61 (acetylenic alcohol-based surfactant, manufactured by Nissin Chemical Industry Co., Ltd.)
TMP Trimethylolpropane
TEG Triethylene glycol
2-P 2-Pyrrolidone
TEA Triethanolamine

TABLE 21
Result of rubbing test in Example C-6 under various heating conditions

| | | | Abrasion | | |
|---|---|---|---|---|---|
| | Temperature | Time | resistance | | |
| | (° C.) | (min) | Dry | Wet | State |
| Example C-6 | 150 | 5 | 5 | 5 | Good |
| Reference Example C-11 | 100 | 5 | 3 | 3 | Good |
| Reference Example C-12 | 150 | 0.5 | 3 | 3 | Good |
| Reference Example C-13 | 210 | 5 | 4 | 4 | Cloth |
| | | | | | yellowed |
| Reference Example C-14 | 210 | 1 | 4 | 4 | Cloth |
| | | | | | yellowed |
| Reference Example C-15 | 100 | 20 | 3 | 3 | Good |

1. An ink set comprising:
an ink composition containing a water-dispersible pigment dispersoid and polymeric microparticles having a glass transition temperature of −10° C. or lower, an acid value of 100 mg KOH/g or less, and prepared using at least alkyl(meth)acrylate and/or cyclic alkyl (meth)acrylate; and
a pigment fixer containing a reaction agent.

2. The ink set according to claim 1, wherein the ink composition further contains a reaction agent.

3. The ink set according to claim 1, wherein the pigment fixer further contains polymeric microparticles having a glass transition temperature of −10° C. or lower, an acid value of 100 mg KOH/g or less, and prepared using at least alkyl (meth)acrylate and/or cyclic alkyl (meth)acrylate.

4. The ink set according to claim 1, wherein the reaction agent is at least one selected from the group consisting of block isocyanates, oxazoline-containing polymers, and polycarbodiimides.

5. The ink set according to claim 1, wherein the alkyl (meth)acrylate and/or cyclic alkyl(meth)acrylate is contained in an amount of 70% by mass or more with respect to the total amount of the polymeric microparticles.

6. The ink set according to claim 1, wherein the alkyl (meth)acrylate and/or cyclic alkyl(meth)acrylate is alkyl(meth)acrylate having 1 to 24 carbon atoms and/or cyclic alkyl (meth)acrylate having 3 to 24 carbon atoms.

7. The ink set according to claim 1, wherein the dispersoid has an average particle size of 50 nm to 300 nm.

8. The ink set according to claim 7, wherein the dispersoid is self-dispersible carbon black capable of dispersing in water without a dispersant and having an average particle size of 50 nm to 300 nm.

9. The ink set according to claim 7, wherein the dispersoid is a polymer-modified water-dispersible organic pigment having an average particle size of 50 nm to 300 nm, the polymer having a weight-average molecular weight of 10,000 to 200,000 in terms of styrene in gel permeation chromatography (GPC).

10. The ink set according to claim 1, wherein the ink composition contains 1,2-alkylene glycol.

11. The ink set according to claim 1, wherein the ink composition contains an acetylenic glycol-based surfactant and/or acetylenic alcohol-based surfactant.

12. The ink set according to claim 1, wherein the polymeric microparticle content (percent by mass) is larger than the pigment content (percent by mass).

13. A method for producing a printed fabric, comprising the steps of:
ink-jet printing an ink composition on fabric, the ink composition containing a water-dispersible pigment dispersoid and polymeric microparticles having a glass transition temperature of −10° C. or lower, an acid value of 100 mg KOH/g or less, and prepared using at least alkyl (meth)acrylate and/or cyclic alkyl (meth)acrylate;
immersing the resulting printed matter in a pigment fixer containing a reaction agent; and
heat-treating the immersed printed matter at a temperature of 110° C. to 200° C. for 1 minute or more.

14. A method for producing a printed fabric, comprising the steps of:
ink-jet printing an ink composition on fabric, the ink composition containing a water-dispersible pigment dispersoid and polymeric microparticles having a glass transition temperature of −10° C. or lower, an acid value of 100 mg KOH/g or less, and prepared using at least alkyl (meth)acrylate and/or cyclic alkyl (meth)acrylate;
applying a pigment fixer containing a reaction agent to the resulting printed matter by an inkjet process; and
heat-treating the printed matter that has been subjected to the application at a temperature of 110° C. to 200° C. for 1 minute or more.

15. The method for producing a printed fabric according to claim 13, wherein the ink composition further contains a reaction agent.

16. The method for producing a printed fabric according to claim 13, wherein the pigment fixer further contains polymeric microparticles having a glass transition temperature of −10° C. or lower, an acid value of 100 mg KOH/g or less, and prepared using at least alkyl (meth)acrylate and/or cyclic alkyl (meth)acrylate.

17. The method for producing a printed fabric according to claim 13, wherein the reaction agent is at least one selected from the group consisting of block isocyanates, oxazoline-containing polymers, and polycarbodiimides.

18. The method for producing a printed fabric according to claim 13, wherein the alkyl (meth)acrylate and/or cyclic alkyl (meth)acrylate is contained in an amount of 70% by mass or more with respect to the total amount of the polymeric microparticles.

19. The method for producing a printed fabric according to claim 13, wherein the alkyl (meth)acrylate and/or cyclic alkyl (meth)acrylate is alkyl (meth)acrylate having 1 to 24 carbon atoms and/or cyclic alkyl (meth)acrylate having 3 to 24 carbon atoms.

20. The method for producing a printed fabric according to claim 13, wherein the dispersoid has an average particle size of 50 nm to 300 nm.

21. The method for producing a printed fabric according to claim 20, wherein the dispersoid is self-dispersible carbon black capable of dispersing in water without a dispersant and having an average particle size of 50 nm to 300 nm.

22. The method for producing a printed fabric according to claim 20, wherein the dispersoid is a polymer-modified water-dispersible organic pigment having an average particle size of 50 nm to 300 nm, the polymer having a weight-average molecular weight of 10,000 to 200,000 in terms of styrene in gel permeation chromatography (GPC).

23. The method for producing a printed fabric according to claim 13, wherein the ink composition contains 1,2-alkylene glycol.

24. The method for producing a printed fabric according to claim 13, wherein the ink composition contains an acetylenic glycol-based surfactant and/or acetylenic alcohol-based surfactant.

25. The method for producing a printed fabric according to claim 13, wherein the polymeric microparticle content (percent by mass) is larger than the pigment content (percent by mass).

26. A printed fabric produced by the method for producing a printed fabric according to claim 13.
